(19) United States
(12) Patent Application Publication
(10) Pub. No.: US 2011/0106939 A1
(43) Pub. Date: May 5, 2011

(54) COMPUTER SYSTEM AND ITS MANAGEMENT METHOD

(75) Inventors: Takeshi Kitamura, Yokohama (JP); Nobuyuki Saika, Yokosuka (JP)

(73) Assignee: Hitachi, Ltd.

(21) Appl. No.: 12/693,308

(22) Filed: Jan. 25, 2010

(30) Foreign Application Priority Data
Nov. 5, 2009 (JP) 2009-254444

(51) Int. Cl. G06F 15/173

(52) U.S. Cl. 709/224

(57) ABSTRACT

Specifically, provided is a computer system, and its management method, including multiple nodes for providing to a host system a storage area to be used for reading and writing data, and respectively acquiring a snapshot at a pre-set time, and which configures a node group from a part or all of the nodes among the multiple nodes and makes data redundant in node units in the node group. With the foregoing computer system and its management method, an access log is acquired from the respective nodes configuring the node group, and the usage of the snapshot in the node group is determined based on the acquired access log of the respective nodes, and the acquisition time of the snapshot is changed in a part or all of the nodes among the nodes configuring the node group based on the determination result.

### CROSS REFERENCES

This application relates to and claims priority from Japanese Patent Application No. 2009-254444, filed on Nov. 5, 2009, the entire disclosure of which is incorporated herein by reference.

### BACKGROUND

The present invention generally relates to a computer system and its management method, and in particular relates to a computer system including a plurality of NASes (Network Attached Storages) loaded with a snapshot function, and which manages a part or the whole thereof as RAIN (Redundant Arrays of Independent Nodes).

Conventionally, the technology of RAIN which is an extension of the concept of RAID (Redundant Arrays of Independent Disks) is known. The difference between RAID and RAIN is that, with RAID, the data protection scheme is considered in disk units and, with RAIN, the data protection scheme is considered in node units. For example, Japanese Patent Laid-Open Publication No. 2008-140387 discloses a case example of storing the parity information of RAID in node units, and not on a disk.

In addition, a standard NAS is loaded with a snapshot function of acquiring a static image of a volume, which is referred to as a snapshot, at a certain point in time. Japanese Patent Laid-Open Publication No. 2007-219609 discloses a snapshot management method of managing snapshots based on the differential between the snapshots that were acquired with such snapshot function.

### SUMMARY

Meanwhile, a case of acquiring a snapshot in a plurality of nodes configuring RAIN is considered.

In the foregoing case, for example, as a result of setting the snapshot acquisition time in the respective nodes so that all nodes will acquire the snapshot at the same time, even if a fault occurs in the node that is being accessed by the user and the processing is subject to a fail-over to another node, the user is able to continue to refer to a snapshot that was acquired at the same time.

Meanwhile, as a result of setting the snapshot acquisition time in the respective nodes so that the respective nodes will acquire the snapshot at different times, in cases where the user erroneously deletes or corrects a file, the number of snapshot versions that can be used upon restoring the file can be increased, and there is an advantage in that the amount of data loss caused by the backdate during the restoration can be reduced.

Nevertheless, since the former and latter methods are mutually contradicting methods, it is difficult to have it both ways. Thus, where is a problem in that, if one method is adopted, the advantage of the other method cannot be enjoyed.

The present invention was devised in view of the foregoing points, and its object is to propose a computer system and its management method capable of improving user-friendliness.

In order to achieve the foregoing object, the present invention provides a computer system including a plurality of nodes for providing to a host system a storage area to be used for reading and writing data and a management server for managing the plurality of nodes, and which configures a node group from a part or all of the nodes among the plurality of nodes and makes data redundant in node units in the node group. With this computer system, the plurality of nodes respectively acquire a snapshot as a static image of the storage area at a pre-set time, and the management server comprises a management unit for managing the plurality of nodes, and a configuration control unit for controlling the configuration of the node group. In addition, the configuration control unit acquires an access log from the respective nodes configuring the node group, determines the usage of the snapshot in the node group based on the acquired access log of the respective nodes, and requests the management unit to change the acquisition time of the snapshot in a part or all of the nodes among the nodes configuring the node group based on the determination result, and the management unit changes the acquisition time of the snapshot set in the corresponding node according to the request from the configuration control unit.

The present invention additionally provides a management method of a computer system including a plurality of nodes for providing to a host system a storage area to be used for reading and writing data and a management server for managing the plurality of nodes, and which configures a node group from a part or all of the nodes among the plurality of nodes and makes data redundant in node units in the node group. With this method, the plurality of nodes respectively acquire a snapshot as a static image of the storage area at a pre-set time, and the method comprises a first step of acquiring an access log from the respective nodes configuring the node group, and a second step of determining the usage of the snapshot in the node group based on the acquired access log of the respective nodes, and changing the acquisition time of the snapshot in a part or all of the nodes among the nodes configuring the node group based on the determination result.

According to the present invention, since the acquisition time of the snapshot of the respective nodes configuring the node group is changed according to the usage of the snapshot, it is possible to enjoy both advantages; namely, the advantage of being able to make the snapshot acquisition time of the respective nodes configuring the node group to all be the same time, and the advantage that can be acquired by causing the snapshot acquisition time of a part or all of the nodes configuring the node group to be different. Consequently, it is possible to improve the user-friendliness of the computer system.

### DESCRIPTION OF DRAWINGS

FIG. 1 is a block diagram showing the hardware configuration of a computer system according to an embodiment of the present invention;

FIG. 2 is a block diagram showing the software configuration of a computer system according to an embodiment of the present invention;

FIG. 3 is a conceptual diagram explaining the management method of a NAS apparatus concerning the RAIN configuration;

FIG. 4 is a conceptual diagram showing the configuration of a RAIN configuration management table;

FIG. 5 is a conceptual diagram explaining RAIN configuration definition information;

FIG. 6 is a schematic diagram of a computer system explaining a RAIN management function according to an embodiment of the present invention;

FIG. 7 is a conceptual diagram explaining a sequential processing flow upon an administrator creating RAIN;

FIG. 8 is a conceptual diagram explaining a sequential processing flow upon an administrator creating RAIN;

FIG. 9 is a conceptual diagram explaining a sequential processing flow upon a client acquiring file sharing information;

FIG. 10 is a conceptual diagram explaining a sequential processing flow upon a client acquiring file sharing information;

FIG. 11 is a conceptual diagram explaining a sequential processing flow upon a client accessing RAIN;

FIG. 12 is a conceptual diagram explaining a sequential processing flow upon a client accessing RAIN;

FIG. 13 is a conceptual diagram explaining a sequential processing flow concerning the evaluation and change of the RAIN configuration;

FIG. 14 is a conceptual diagram explaining a sequential processing flow concerning the evaluation and change of the RAIN configuration;

FIG. 15 is a conceptual diagram explaining a sequential processing flow upon a client accessing RAIN after the RAIN configuration is changed;

FIG. 16 is a conceptual diagram explaining a sequential processing flow upon a client accessing RAIN after the RAIN configuration is changed;

FIG. 17 is a conceptual diagram explaining a sequential processing flow upon a client accessing RAIN after the RAIN configuration is changed;

FIG. 18 is a conceptual diagram explaining a sequential processing flow concerning the change of the snapshot acquisition time;

FIG. 19A and FIG. 19B are conceptual diagrams explaining a sequential processing flow concerning the change of the snapshot acquisition time;

FIG. 20 is a conceptual diagram explaining a sequential processing flow concerning the change of the snapshot acquisition time;

FIG. 21 is a conceptual diagram explaining a sequential processing flow concerning the change of the snapshot acquisition time;

FIG. 22A and FIG. 22B are conceptual diagrams explaining a sequential processing flow concerning the change of the snapshot acquisition time;

FIG. 23 is a block diagram showing the relationship between programs;

FIG. 24 is a flowchart showing the processing routine of access request processing;

FIG. 25 is a flowchart showing the processing routine of RAIN configuration information acquisition processing;

FIG. 26 is a flowchart showing the processing routine of snapshot list acquisition processing;

FIG. 27 is a flowchart showing the processing routine of read processing;

FIG. 28 is a flowchart showing the processing routine of write processing;

FIG. 29 is a flowchart showing the processing routine of RAIN configuration information reply processing;

FIG. 30 is a flowchart showing the processing routine of RAIN configuration control processing;

FIG. 31 is a flowchart showing the processing routine of RAIN configuration change processing; and

FIG. 32 is a flowchart showing the processing routine of snapshot acquisition interval change processing.

### DETAILED DESCRIPTION

An embodiment of the present invention is now explained in detail with reference to the attached drawings.

### (1) Configuration of Computer System in Present Embodiment

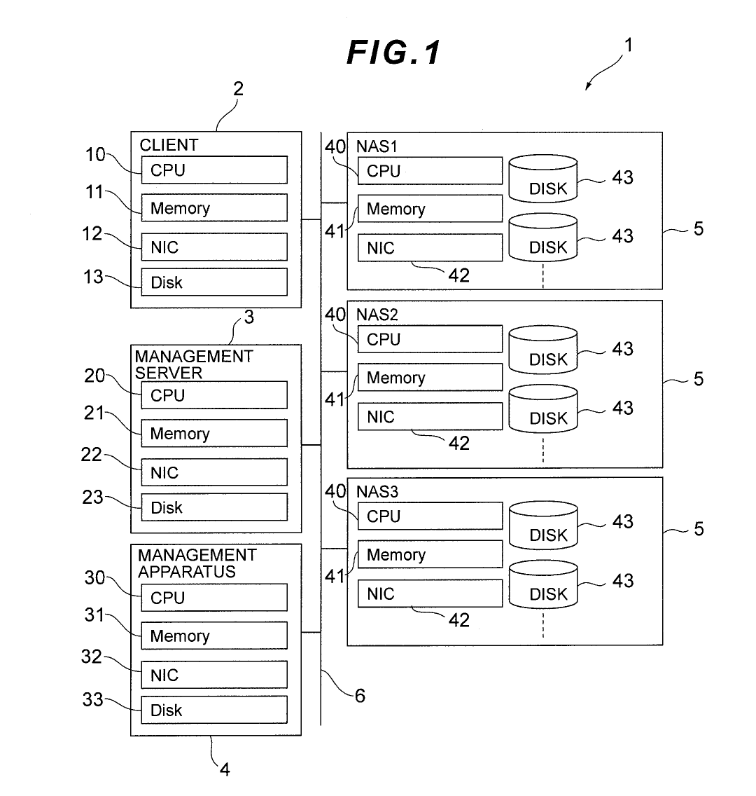

FIG. 1 shows the hardware configuration of a computer system 1 according to the present embodiment. The computer system 1 is configured by one or more clients 2, a management server 3, a management apparatus 4, and a plurality of NAS apparatuses 5 being connected via a network 6 such as a LAN (Local Area Network).

The client 2 is a computer system that is used by the user for accessing the NAS apparatus 5, and is configured from a personal computer, a mainframe or the like. The client 2 comprises information processing resources such as a CPU (Central Processing Unit) 10, a memory 11, an NIC (Network Interface Card) 12 and a hard disk device 13, and is connected to the network 6 via the NIC 12.

The management server 3 is a server apparatus that is used for managing the configuration of the NAS apparatus 5, and comprises information processing resources such as a CPU 20, a memory 21, an NIC 22, and a hard disk device 23. The management server 3 is also connected to the network 6 via the NIC 22, and the client 2, the management apparatus 4 and the NAS apparatus 5 are able to communicate via the network 6.

The management apparatus 4 is a computer device that is used by the administrator for managing the NAS apparatus under the RAIN configuration, and is configured from a personal computer, a mainframe or the like. The management apparatus 4 comprises, as with the client 2, information processing resources such as a CPU 30, a memory 31, an NIC 32 and a hard disk device 33, and is connected to the network 6 via the NIC 32.

The NAS apparatus 5 is a server apparatus for providing a file sharing service to the client 2, and comprises information processing resources such as a CPU 40, a memory 41 and an NIC 42. The NAS apparatus 5 is also connected to the network 6 via the NIC 42, and is able to communicate with the client 2 and the management server 3 via the network 6.

The NAS apparatus 5 also comprises one or more disk devices 43. The disk devices 43 are configured, for example, from expensive disks such as SCSI (Small Computer System Interface) disks or inexpensive disks such as SATA (Serial AT Attachment) disks or optical disks. One or more logical volumes are set in a physical storage area provided by one or more disk devices 43, and data from the client is retained in the logical volume in file units.

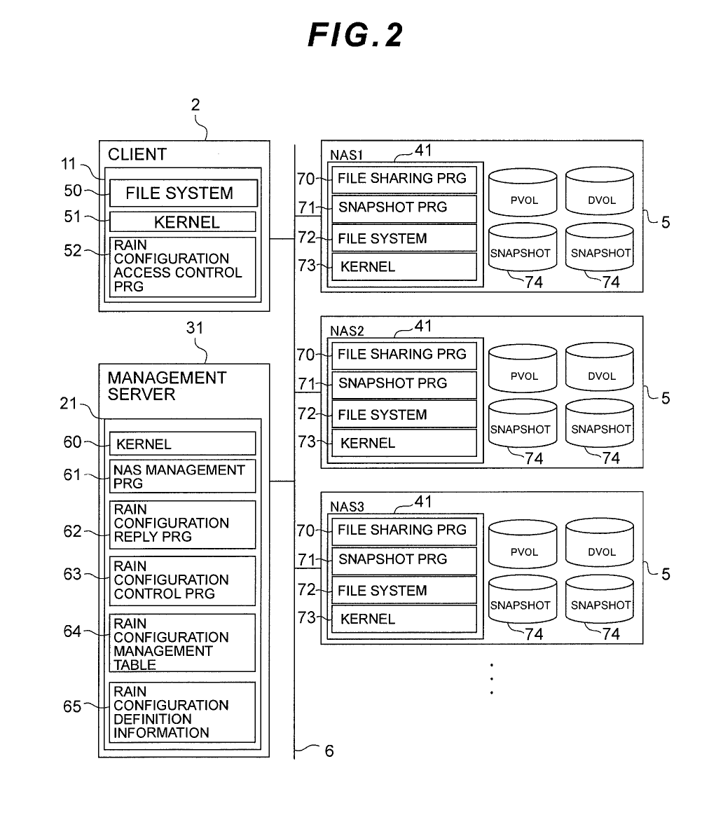

FIG. 2 shows the software configuration of the computer system 1. Incidentally, the management apparatus 4 is omitted in FIG. 2.

As shown in FIG. 2, the memory 11 of the client 2 stores a file system program 50, a kernel 51, and a RAIN configuration access control program 52. The file system program 50 is a program for managing the file system. A file system is a logical structure that is created in order to realize a management unit referred to as a “file” in the physical volume. The kernel 51 is an operating system for performing the overall control of client 2. Details concerning the RAIN configuration access control program 52 will be explained later.

The memory 21 of the management server 3 stores programs such as a kernel 60, a NAS management program 61, a RAIN configuration reply program 62 and a RAIN configuration control program 63, and control information such as a RAIN configuration management table 64 and RAIN configuration definition information. The kernel 60 is an operating system that performs the overall control of the management server 3. The NAS management program 61 is a program for managing the NAS apparatus 5, and configures various settings for the file sharing to the NAS apparatus 5 and configures various settings for acquiring the snapshot 74. Details concerning the RAIN configuration reply program 62, the RAIN configuration control program 63, the RAIN configuration management table 64 and the RAIN configuration definition information will be explained later.

The memory 41 of the NAS apparatus 5 stores a file sharing program 70, a snapshot program 71, a file system program 72 and a kernel 73. The file sharing program 70 is a program that uses a communication protocol such as CIFS (Common Internet File System) or NFS (Network File System) to provide the file sharing service to the client 2.

The snapshot program 71 is a program for acquiring a plurality of generations of snapshots 74. In the case of this embodiment, the snapshot program 71 acquires the snapshot 74 at a pre-set snapshot acquisition time. The file system program 72 is a program for providing the file sharing service to the client 2, and the kernel 73 is an operating system for performing the overall control of the NAS apparatus 5.

In FIG. 2, the term “PVOL” in the NAS apparatus 5 shows the logical volume (hereinafter referred to as the “operating volume PVOL”) that is created by the file sharing program 70 and provided to the client 2. The operating volume PVOL is used by the client 2 for reading and writing data. In addition, the term “DVOL” show the logical volume (hereinafter referred to as the “differential volume DVOL”) that is used for saving the old data before the update when the operating volume is updated in order to acquire the snapshot 74.

### (2) RAIN Management Function in Present Embodiment

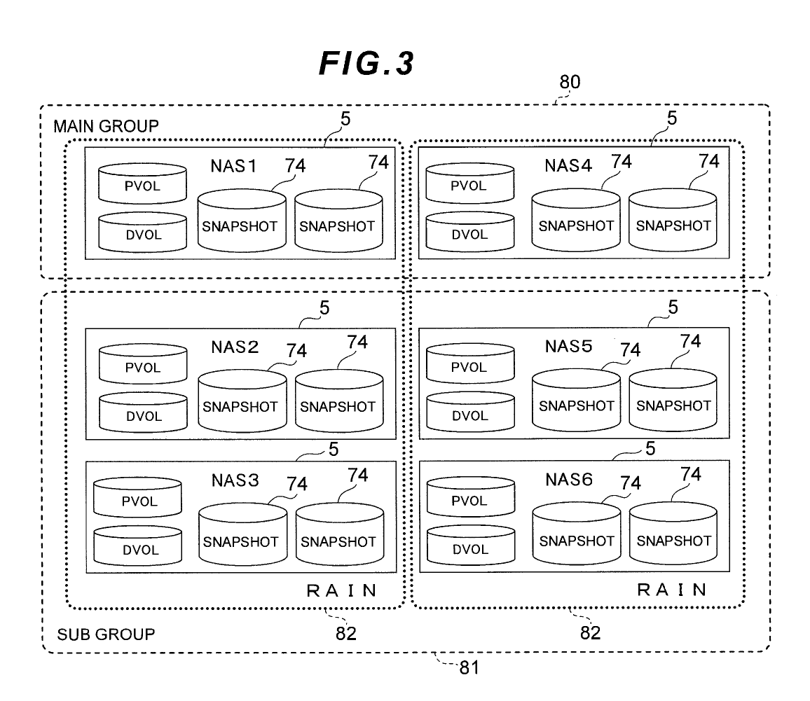

In the case of the computer system 1, the NAS apparatus 5 connected to the network 6 is managed, as shown in FIG. 3, by being divided into a group (hereinafter referred to as the “main group”) 80 that is directly managed by the administrator, and a group (hereinafter referred to as the “sub group”) 81 that is not directly managed by the administrator. A single NAS apparatus 5 will never belong to both the main group 80 and the sub group 81. The various settings to the NAS apparatus 5 such as for creating the file system are only implemented by the administrator to the NAS apparatus 5 of the main group 80. As described above, since the various settings to the NAS apparatus 5 of the sub group 81 are performed by the NAS management program 61 of the management server 3, the administrator is not required to execute the various settings to the NAS apparatus 5 of the sub group 81.

The RAIN 82 is configured from one NAS apparatus 5 belonging to the main group 80, and the NAS apparatuses 5 belonging to the sub group 81. For instance, in the example shown in FIG. 3, the NAS apparatuses 5 belonging to the main group 80 are “NAS 1” and “NAS 4,” and the NAS apparatuses 5 belonging to the sub group 81 are “NAS 2,” “NAS 3,” “NAS 5” and “NAS 6,” and one RAIN 82 is configured from “NAS 1,” “NAS 2” and “NAS 3,” and another RAIN 82 is configured from “NAS 4,” “NAS 5” and “NAS 6.”

The RAIN management function loaded in the computer system 1 is now explained. The computer system 1 is loaded with a RAIN management function for dynamically changing the configuration of the RAIN 82 to which the NAS apparatus 5 based on the usage of that NAS apparatus 5, and dynamically changing the acquisition interval of the snapshots 74 in the RAIN 82 to which the NAS apparatus 5 belongs based on the usage of the snapshots 74 acquired in the NAS apparatus 5.

As means for realizing this kind of RAIN management function, as shown in FIG. 2, the memory 11 of the client 2 stores the RAIN configuration access control program 52, and the memory 21 of the management server 3 stores the RAIN configuration reply program 62, the RAIN configuration control program 63, the RAIN configuration management table 64 and the RAIN configuration definition information 65 as described above.

The RAIN configuration access control program 52 is a program that is used by the client 2 for making an inquiry to the RAIN configuration reply program 62 of the management server 3 regarding any available NAS apparatuses 5, and accessing such available NAS apparatus 5. The RAIN configuration access control program 52 also comprises a function of making an inquiry to the RAIN configuration reply program 62 of the management server 3 regarding the snapshots 74 existing in the RAIN 82, and present the list thereof (hereinafter referred to as the “snapshot list”) to the user.

The RAIN configuration reply program 62 is a program that is used by the management server 3 to reply to the client to on any available RAIN 82 in response to an inquiry from that client 2, accessing the NAS apparatus 5 in the RAIN 82 to collect necessary information concerning that NAS apparatus, and notifying the collected information to the client 2.

The RAIN configuration control program 63 is a program for controlling the configuration of the RAIN 82, and manages the NAS apparatus 5 connected to the network 6 by dividing it into a main group 80 (FIG. 3) and a sub group 81 (FIG. 3) as described above, and executes processing of dynamically adding a NAS apparatus 5 of the sub group 81 to the RAIN 82 or deleting a NAS apparatus 5 of the sub group 81 from the RAIN 82 according to the usage of the NAS apparatus 5 configuring the RAIN 82.

The RAIN configuration control program 63 also comprises a function of managing the acquisition time of the snapshots 74 set to the respective NAS apparatuses 5 configuring the RAIN 82, and dynamically changing the acquisition interval of the snapshots 74 of the overall RAIN 82 via the NAS management program 61.

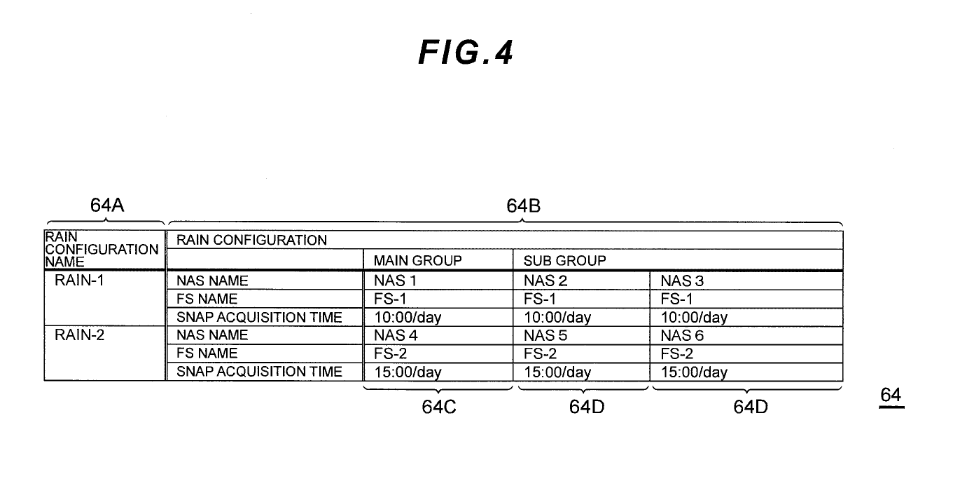

Meanwhile, the RAIN configuration management table 64 is a table for managing the RAIN 82 defined in the computer system 1 and is configured, as shown in FIG. 4, from a RAIN configuration name column 64A and a RAIN configuration column 64B. The RAIN configuration name column 64A stores the name (“RAIN configuration name”) of each RAIN 82 set in the computer system 1.

The RAIN configuration column 64B is configured from one main group column 64C, and one or more sub group columns 64D. The main group column 64C stores the name (“NAS name”) of the NAS apparatus 5 configuring the corresponding RAID 82 and which belongs to the main group 80, the name (“FS name”) of the file system set in that NAS apparatus 5, and the snapshot acquisition time (“snap acquisition time”) set in that NAS apparatus 5. The sub group column 64D stores the name of each NAS apparatus 5 configuring the corresponding RAIN 82 and which belongs to the sub group 81, the name of the file system set in that NAS apparatus 5, and the acquisition time of the snapshot 74 set in that NAS apparatus 5.

Accordingly, the case of the example illustrated in FIG. 4 shows that the RAIN 82 named “RAIN-1” is configured from the NAS apparatus 5 named “NAS 1” belonging to the main group 80, and two NAS apparatuses 5 named “NAS 2” and “NAS 3” belonging to the sub group 81. Moreover, a file system named “FS-1” is set on each of the foregoing three NAS apparatuses 5, and the three NAS apparatuses 5 are set so as to acquire a snapshot 74 at “10:00” every day.

In the ensuing explanation, the name of the NAS apparatus 5, the name of the file system set in that NAS apparatus 5, and the snapshot acquisition time set in that NAS apparatus 5 are collectively referred to as the NAS apparatus information of that NAS apparatus 5 when appropriate.

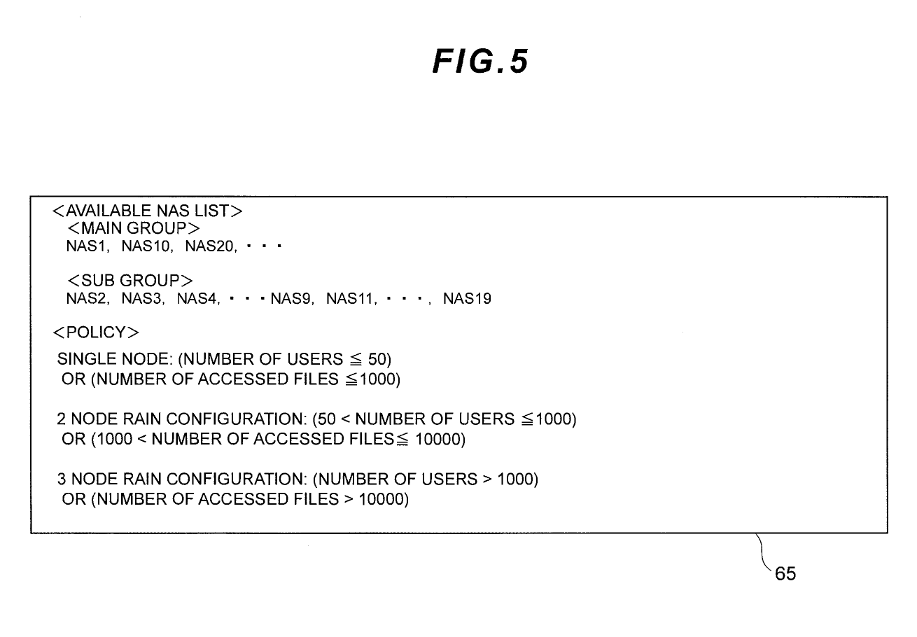

The RAIN configuration definition information 65 is information concerning the definition of the RAIN configuration that is defined by the administrator in advance. The RAIN configuration definition information 65 includes, as shown in FIG. 5, as a list of available NAS apparatuses 5, the name of each NAS apparatus sorted to the main group 80, and the name of each NAS apparatus 5 sorted to the sub group 81. The RAIN configuration definition information 65 also includes conditions that are defined by the administrator in advance as the conditions (hereinafter referred to as the “RAIN configuration policy”) for adding a NAS apparatus 5 to the RAIN 82 or deleting a NAS apparatus 5 from the RAIN 82.

Accordingly, the case of the example illustrated in FIG. 5 shows that, among the available NAS apparatuses 5, the NAS apparatuses 5 named “NAS 1,” “NAS 10” and “NAS 20” are sorted to the main group 80, and the other NAS apparatuses 5 named “NAS 2” to “NAS 9” and “NAS 11” to “NAS 19” are sorted to the sub group 81.

Moreover, in FIG. 5, as the RAIN configuration policy, it is defined that only one NAS apparatus 5 belonging to the main group 80 should be used to configure the RAIN 82 if the number of users (number of accessing users) who accessed the NAS apparatus 5 is “50” users or less or if the number of files (number of accessed files) accessed by users in the NAS apparatus 5 is “1000” or less, one NAS apparatus 5 belonging to the main group and one NAS apparatus 5 belonging to the sub group 81 should be used to configure the RAIN 82 if such number of accessing users is “51” to “1000” users or if such number of accessed files is “1001” to “10000,” and one NAS apparatus 5 belonging to the main group 80 and two NAS apparatuses 5 belonging to the sub group 81 should be used to configure the RAIN 82 if the number of accessing users is greater than “1000” users or if the number of accessed files is greater than “10000.”

### (3) Outline of Processing Concerning RAIN Management Function

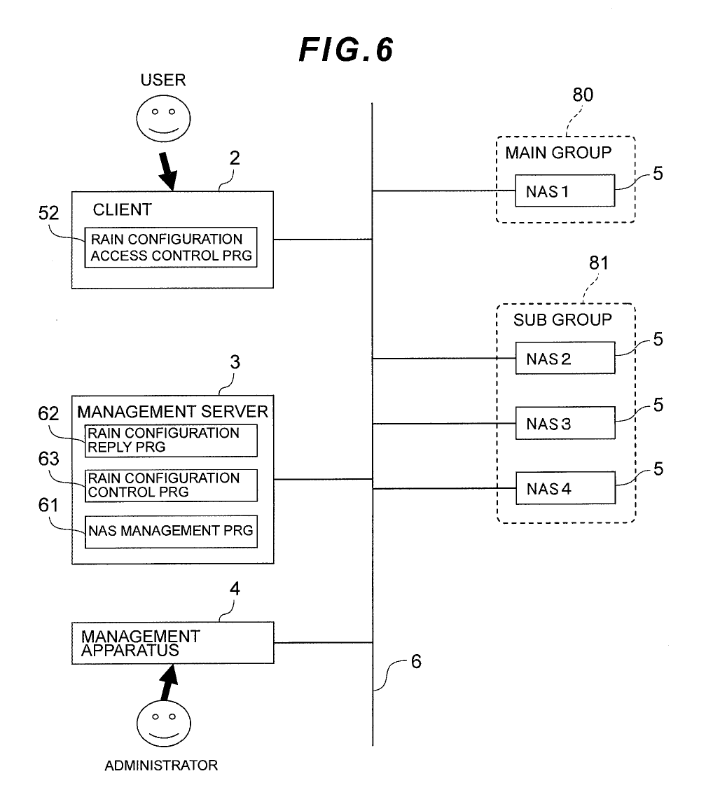

The sequential flow to be executed in relation to the RAIN management function according to this embodiment is now explained. In the ensuing explanation, as shown in FIG. 6, the explanation will be based on the premise that a NAS apparatus 5 named “NAS 1” belonging to the main group 80 and three NAS apparatuses 5 named “NAS 2,” “NAS 3” and “NAS 4” belonging to the sub group 81 are connected via the network 6.

In addition, although the processing subject of the various types of processing in the ensuing explanation is referred to as a “program,” in reality, it goes without saying that the corresponding CPU 10 (FIG. 1) of the client 2, the CPU 20 (FIG. 1) of the management server 3, or the CPU 40 (FIG. 1) of the NAS apparatus 5 executes such processing based on the “program.”

(3-1) Creation of RAIN by Administrator

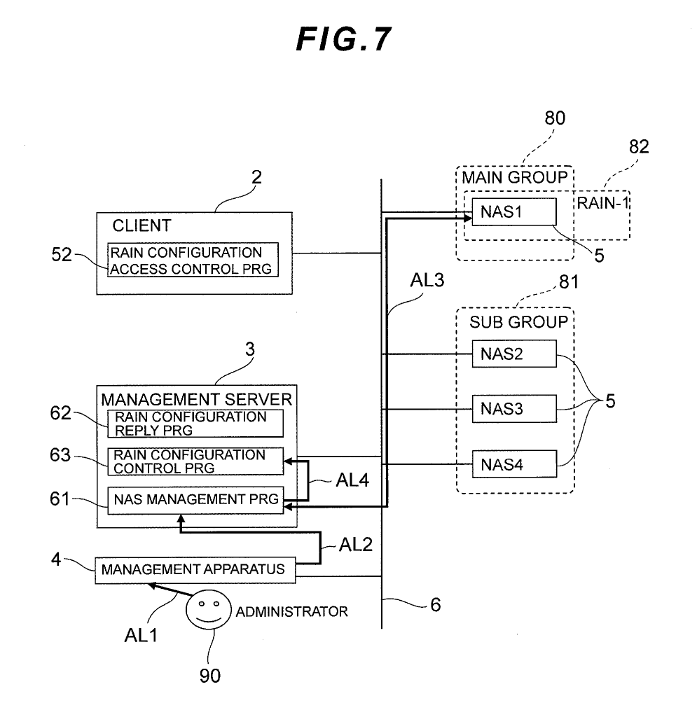

Foremost, as shown in FIG. 7, the administrator 90 inputs into the management apparatus 4 the contents of the various settings for providing file sharing to the intended NAS apparatus 5 (NAS 1″ in the case of FIG. 6) belonging to the main group 80, and the contents of the various settings for acquiring the snapshot 74 (AL1). Incidentally, as the “settings for file sharing,” there are the creation of a logical volume, creation of a file system, and setting of a shared user, and as the “settings for acquiring a snapshot,” there are the setting of the acquisition time of the snapshot 74 the setting of the differential volume DVOL, and so on. Then, a setting request corresponding to the contents of the various settings input by the administrator 90 is sent from the management apparatus 4 to the NAS management program 61 of the management server 3 (AL2).

When the NAS management program 61 receives the setting request, it notifies the contents of the various settings input by the administrator 90 into the management apparatus 4 to the target NAS apparatus 5 (“NAS 1” in FIG. 7) (AL3). Consequently, the NAS apparatus 5 performs the various settings for file sharing and the various settings for acquiring the snapshot 74 according to the foregoing notice as per the contents designated by the administrator 90.

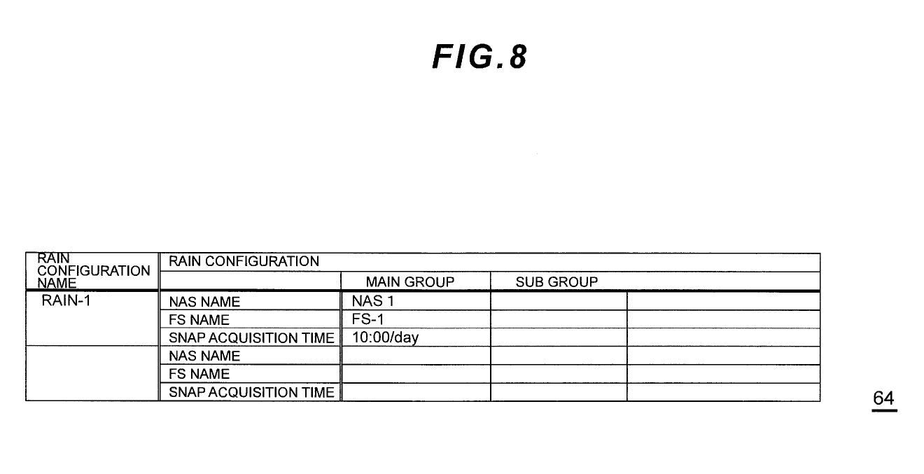

The NAS management program 61 sends to the RAIN configuration control program 63 a RAIN configuration management table update request including the NAS apparatus information of the NAS apparatus 5 (“NAS 1”) that performed the various settings for file sharing and the various settings for acquiring the snapshot 74 (AL4). Consequently, the RAIN configuration control program 63 registers, in the RAIN configuration management table 64, necessary information concerning the new RAIN 82 that is configured by the NAS apparatus 5 (“NAS 1”) based on the RAIN configuration management table update request as shown in FIG. 8.

(3-2) Acquisition of File Sharing Information by Client

Meanwhile, the user is able to acquire file sharing information such as a list of file systems that are available to the user or a list of snapshots 74 can be accessed by the user as a result of using the client 2.

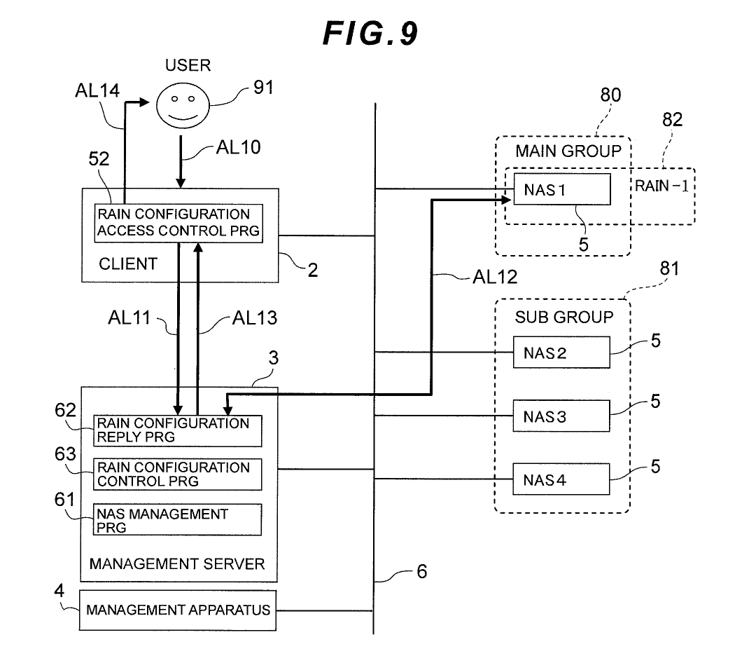

In reality, as shown in FIG. 9, when the user 91 operates the client 2 and sends a command for acquiring such file sharing information to the client 2 (AL10), in response, the RAIN configuration access control program 52 of the client 2 makes an inquiry to the RAIN configuration reply program 62 of the management server 3 regarding the file systems that are available to the user 91 (AL11).

Here, the RAIN configuration reply program 62 detects the RAIN 82 that is accessible by the user 81 which is being managed with a user management table (not shown), and acquires, from the RAIN configuration management table 64, the NAS apparatus information of the respective NAS apparatuses 5 (only “NAS 1” in FIG. 9) configuring that RAIN 82. Moreover, the RAIN configuration reply program 62 accesses the respective NAS apparatus 5 (“NAS 1”) from which it acquired the NAS apparatus information, and acquires file sharing information such as the file system created in that NAS apparatus 5 and a list of snapshots retained by that NAS apparatus 5 (AL12).

Then, the RAIN configuration reply program 62 notifies the RAIN configuration access control program 52 of the file sharing information of the respective NAS apparatuses 5 which was acquired as described above (AL13). Consequently, the RAIN configuration access control program 52 present the file sharing information to the user 91 such by displaying the file sharing information on the display of the client 2 (AL14).

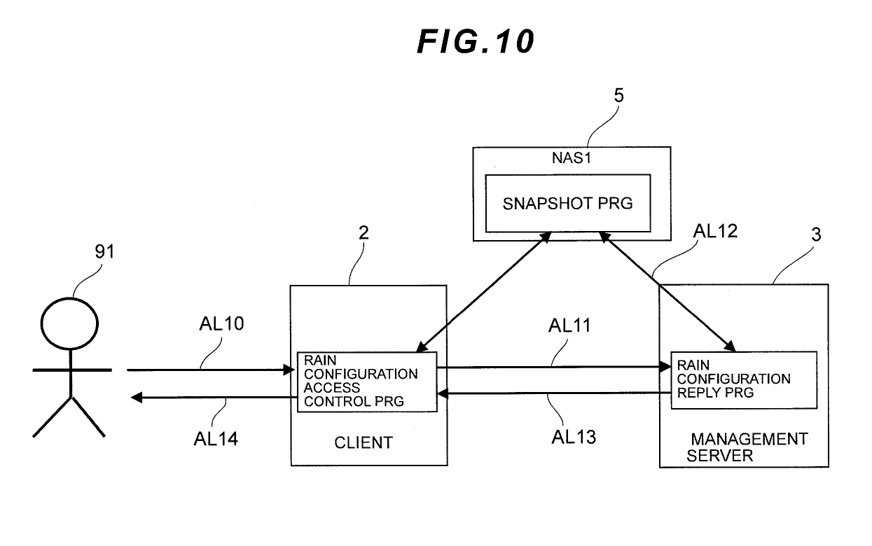

The relationship of the user 91, the client 2, the management server 3 and the NAS apparatus 5 in the foregoing sequential processing is shown in FIG. 10.

(3-3) Access by Client

When the foregoing sequential processing is completed, the user 91 will be able to access the RAIN 82 to which the access by the user 91 has been permitted by using the client 2.

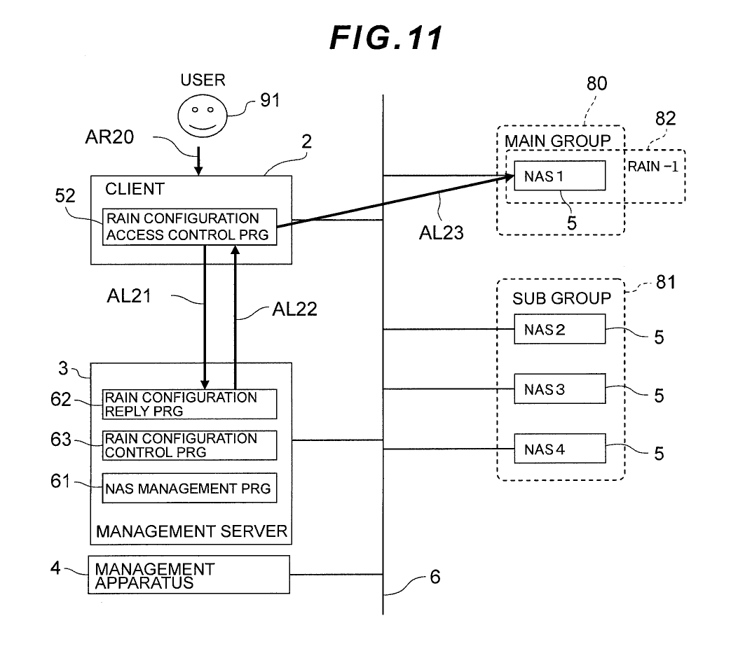

In reality, as shown in FIG. 11, for instance, if the user 91 operates the client 2 an inputs a file write command to the RAIN 82 (“RAIN-1” in FIG. 11) to which the access by the user 91 has been permitted (AL20), the RAIN configuration access control program 52 of the client 2 makes an inquiry regarding the RAIN configuration of that RAIN 82 by sending a RAIN configuration information transfer request to the RAIN configuration reply program 62 of the management server 3 (AL21).

The RAIN configuration reply program 62 acquires, in response to the inquiry, the NAS apparatus information of all NAS apparatuses 5 configuring that RAIN 82 from the RAIN configuration management table 64, and transfers the acquired NAS apparatus information as the NAS configuration information to the client 2 (AL22).

Consequently, the RAIN configuration access control program 52 of the client 2 that received the NAS configuration information sends a write request and write data (file data) to the NAS apparatus 5 configuring that RAIN 82 (AL23). In the RAIN configuration, since all NAS apparatuses 5 configuring the same RAIN 82 retain the same data, the write request and write data are sent to all NAS apparatuses 5 configuring that RAIN 82 upon writing data. However, in the case of this example, since the NAS apparatus 5 configuring the RAIN 82 at this stage is only the NAS apparatus 5 (“NAS 1”) belonging to the main group 80, the write request and write data are sent only to that NAS apparatus 5.

The file system of the NAS apparatus 5 that received the write request and write data writes such write data into the operating volume PVOL according to the write request.

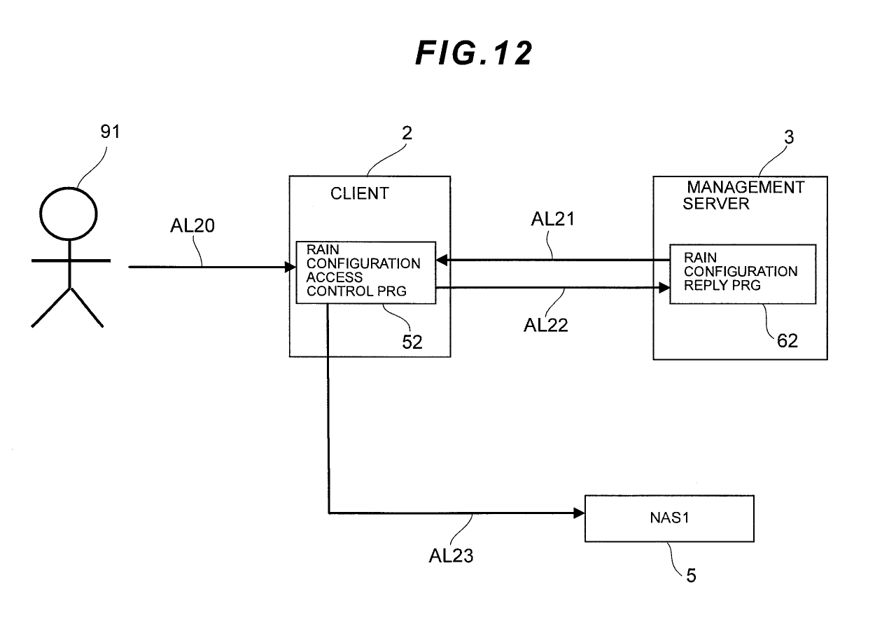

The relationship of the user 91, the client 2, the management server 3 and the NAS apparatus 5 in the foregoing sequential processing is shown in FIG. 12.

(3-4) Evaluation and Change of RAIN Configuration

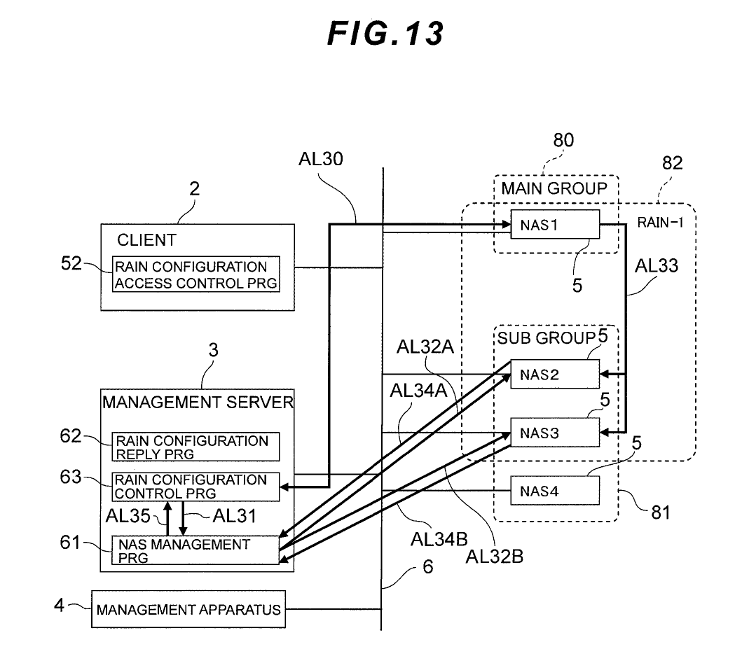

Meanwhile, as shown in FIG. 13, the RAIN configuration control program 63 of the management server 3 is periodically monitoring the number of accessing users to the respective NAS apparatuses 5 (only “NAS 1” at this stage) configuring the RAIN 82, and the number of accessed files in the NAS apparatuses 5 (AL30). The RAIN configuration control program 63 determines whether it is necessary to change the RAIN confirmation of that RAIN 82 based on the monitoring result and the RAIN configuration policy that is defined in the RAIN configuration definition information 65 explained above with reference to FIG. 5.

If the RAIN configuration control program 63 determines, for example, that it is necessary to add a NAS apparatus 5 to the RAIN 82, it selects the required number of NAS apparatus 5 (“NAS 2” and “NAS 3” and FIG. 13) among the NAS apparatuses 5 that are sorted to the sub group 81 in the RAIN configuration definition information 65, and requests the NAS management program 61 to perform various settings for file sharing and various settings for acquiring snapshots to these NAS apparatuses 5 in the same contents as the existing NAS apparatuses 5 in the RAIN 82 (AL31).

Consequently, the NAS management program 61 performs, in response to the request, various settings for file sharing and various settings for acquiring snapshots to the NAS apparatuses 5 selected as described above in the completely same contents as the NAS apparatus 5 (“NAS 1”) belonging to the main group 80 in that RAIN 82 (AL32A, AL32B).

When such various settings for file sharing and various settings for acquiring snapshots are complete, the NAS apparatuses 5 (“NAS 2” and “NAS 3”) that were newly added to the RAIN 82 synchronizes data with the NAS apparatuses 5 belonging to the main group 80 in that RAIN 82 by downloading, from the NAS apparatuses 5 belonging to the main group 80 in that RAIN 82, all data stored in the operating volume PVOL of such NAS apparatuses 5 to the operating volume PVOL of the self-NAS apparatus 5 (AL33). When the NAS apparatuses 5 (“NAS 2” and “NAS 3”) that were newly added to the RAIN 82 complete the foregoing download, they send a download completion notice to the NAS management program 61 of the management server 3 (AL34A, AL34B).

When the NAS management program 61 receives the download completion notice from all NAS apparatuses 5 that were newly added, it sends to the RAIN configuration control program 63 the NAS apparatus information of those NAS apparatuses 5 and a RAIN configuration management table update request including the RAIN name of that RAIN 82 (AL35).

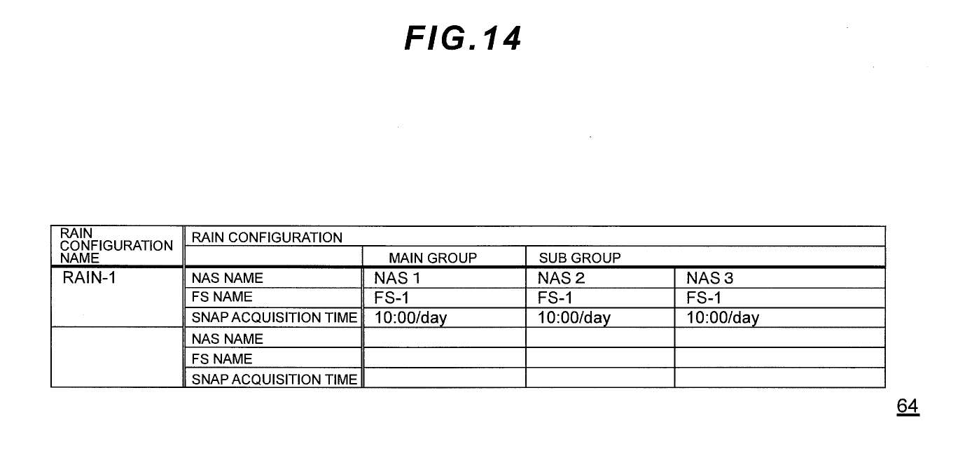

Consequently, the RAIN configuration control program 35 additionally registers the added NAS apparatuses 5 as NAS apparatuses configuring that RAIN 82 based on the RAIN configuration management table update request as shown in FIG. 14.

(3-5) Acceptance of Access from Client after Change of Configuration

If the RAIN configuration is changed as described above, and the user, for example, thereafter operates the client 2 to input a file write command to that RAIN 82 (AL40), the same processing as the processing explained above with reference to FIG. 11 is performed. Nevertheless, in the foregoing case, the RAIN configuration access control program 52 of the client 2 acquires the RAIN configuration information of the RAIN 82 after the change of configuration as the reply from the RAIN configuration reply program 62 to the RAIN configuration information transfer request (AL41) (AL42).

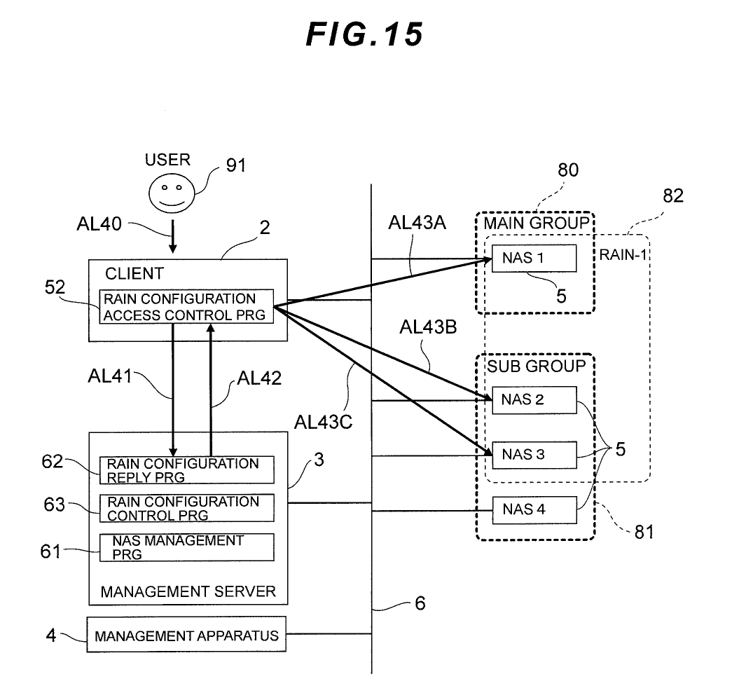

Consequently, the RAIN configuration access control program 52 of the client 2 that received the RAIN configuration information of the RAIN 82 after the foregoing change of configuration sends, as shown in FIG. 15, a write request and write data to all NAS apparatuses 5 (“NAS 1,” “NAS 2” and “NAS 3” in FIG. 15) configuring that RAIN 82 (AL43A to AL43C).

Moreover, the file system of the respective NAS apparatuses 5 that received the write request and write data write the write data into the operating volume PVOL according to the received write request. The write data is thereby written redundantly in a plurality of NAS apparatuses 5.

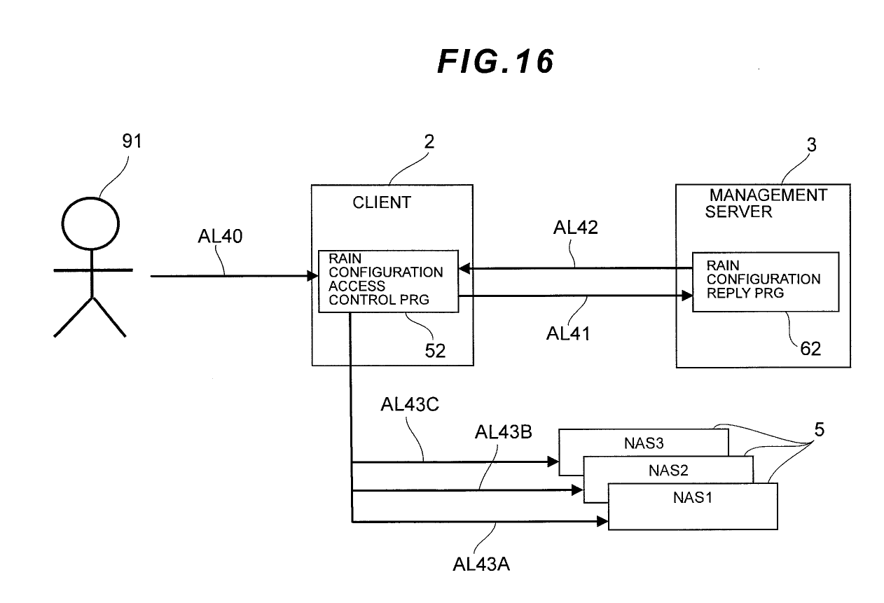

The relationship of the user 91, the client 2, the management server 3 and the NAS apparatus 5 in the foregoing sequential processing is shown in FIG. 16.

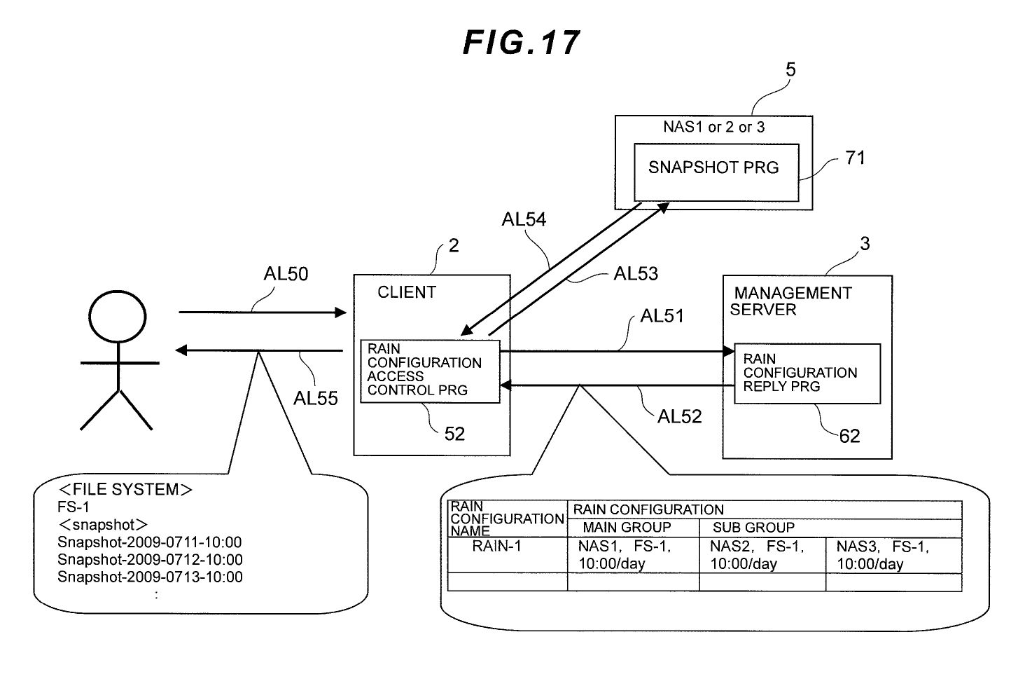

In addition, the relationship of the user 91, the client 2, the management server 3 and the NAS apparatus 5 in a case where, after the RAIN configuration of the RAIN 82 is changed, the user 91 inputs a display command to the client 2 for displaying the file systems and snapshots available to the user 91 is shown in FIG. 17.

When the user 91 inputs such display command to the client 2 (AL50), the RAIN configuration access control program 52 of the client 2 makes an inquiry to the RAIN configuration reply program 62 of the management server 3 regarding the RAIN configuration of the corresponding RAIN 82 (AL51).

The RAIN configuration reply program 62 acquires, in response to the inquiry, the NAS apparatus information of all NAS apparatuses 5 configuring that RAIN 82 from the RAIN configuration management table 64, and notifies the acquired NAS apparatus information as the RAIN configuration information to the client 2 (AL52).

The RAIN configuration access control program 52 of the client 2 that received the RAIN configuration information requests the respective NAS apparatuses 5 configuring that RAIN 82 to notify the file systems and the snapshots 74 that are available to that user 91 (AL53).

The respective NAS apparatuses 6 that received the foregoing request notify the RAIN configuration access control program 54 of the name of the file systems that are available to that user 91 and management information such as the snapshot name and acquisition time of the respective snapshots 74 that are available to that user 91 (AL54).

Consequently, the RAIN configuration access control program 52 creates a snapshot list indicating the name of file systems that are available to the user 91 and the acquisition time of the respective snapshots 74 that are available to that user 91 based on the name of the file systems and the management information of the respective snapshots 74 that are sent from those NAS apparatuses 5, and presents this to the user 91.

(3-6) Control of Snapshot Acquisition Interval (Part 1)

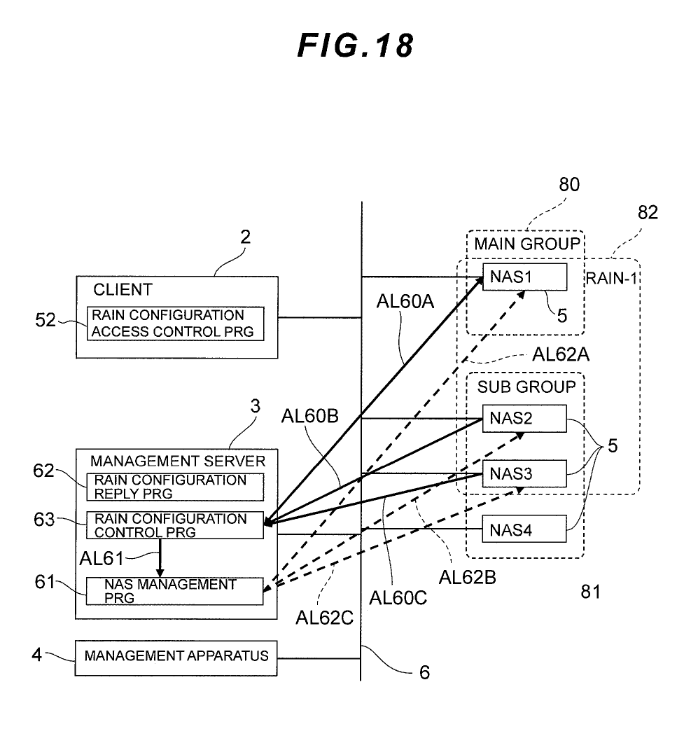

Meanwhile, the RAIN configuration control program 63 of the management server 3 periodically collects, as shown in FIG. 18, the access log from the respective NAS apparatuses 5 configuring each RAIN 82 (AL60A to AL60C).

The RAIN configuration control program 63 refers to each of the collected access logs and determines whether the user as previously restored the file. If the RAIN configuration control program 63 determines that the user has previously restored the file, it specifies the time (hereinafter referred to as the “restoration time”), and seeks the time difference between the acquisition time of the snapshot 74 used for such restoration, and the restoration time.

For instance, if the restoration time of the restoration of any one of the files executed in a certain NAS apparatus 5 was “8:00,” “14:00” and “16:00” and the acquisition time of the snapshot 74 that was used in such restoration was “10:00,” then the time difference will be “−2 hours,” “+4 hours” and “+6 hours,” respectively.

Then the RAIN configuration control program 63 requests the NAS management program 61 to change the snapshot acquisition time of the NAS apparatus 5 that is required among the NAS apparatuses 5 configuring that RAIN 82 if the average value of the time difference exceeds a pre-set threshold (hereinafter referred to as the “snapshot control threshold”).

Specifically, the RAIN configuration control program 63 decides the new snapshot acquisition time in each NAS apparatus 5 configuring that RAIN 82 if the average value of the time difference between the acquisition time and the restoration time of the snapshots 74 in the RAIN 82 exceeds the snapshot control threshold.

Incidentally, as a method of deciding the new snapshot acquisition time, for example, employed may be a method of deciding the snapshot acquisition time of each NAS apparatus 5 so that the time interval of the acquisition time of the snapshots 74 of each NAS apparatus 5 becomes a time interval that corresponds to the size of the average value of the time difference between the acquisition time and the restoration time of the snapshots 74. Moreover, in an operation of acquiring a snapshot 74 on a daily basis, employed may be a method of deciding the snapshot acquisition time of each NAS apparatus 5 so that snapshots 74 are sequentially acquired at a time interval that is obtained by dividing 24 hours with the total number of NAS apparatuses 5 configuring that RAIN 82.

Then the RAIN configuration control program 63 sends to the NAS management program 61 a request (hereinafter referred to as the “snapshot acquisition time change request”) for changing the snapshot acquisition time set in the corresponding NAS apparatus 5 to the snapshot acquisition time of that NAS apparatus 5 that was decided as described above (AL61).

When the NAS management program 61 receives the snapshot acquisition time change request, it notifies the acquisition time change request of the snapshot 74 and the new snapshot acquisition time to the respective NAS apparatuses 5 configuring that RAIN 82 (AL62A to AL62C).

Consequently, the respective NAS apparatuses 5 that received the foregoing change request changes the snapshot acquisition time that is set in itself to the new snapshot acquisition time that was notified from the NAS management program 61.

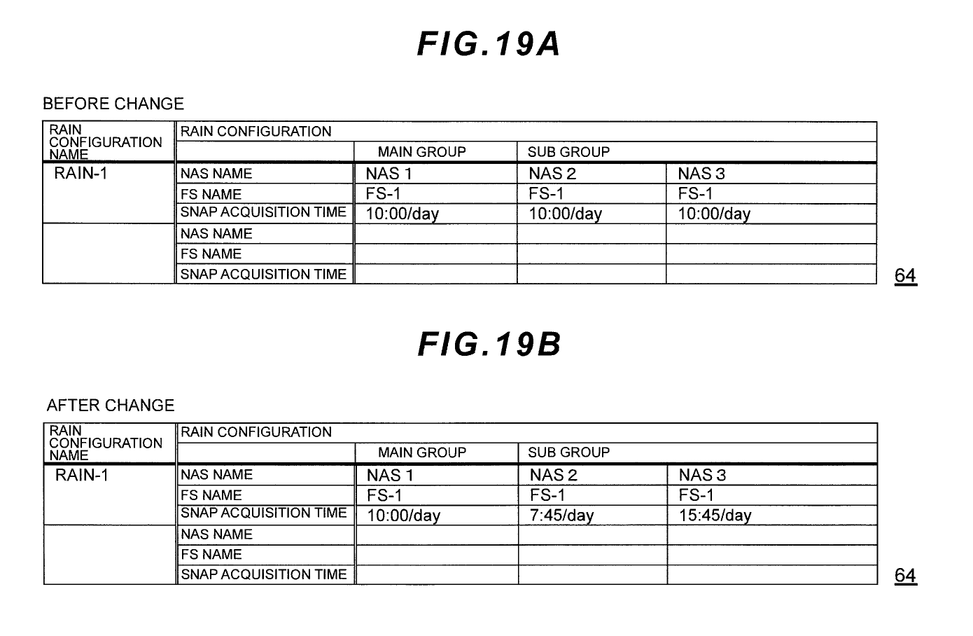

Here, the RAIN configuration control program 63 also updates the RAIN configuration management table 64, for instance, as shown in FIG. 19, according to the change in the snapshot acquisition time of the NAS apparatus 5.

Incidentally, FIG. 19A shows the RAIN configuration management table 64 before the update, and FIG. 19B shows the RAIN configuration management table 64 after the update. FIG. 19 shows that the snapshot acquisition time of the NAS apparatus 5 named “NAS 2” of the RAIN 82 named “RAIN-1” was changed from “10:00/day” to “7:45/day,” and the snapshot acquisition time of the NAS apparatus 5 named “NAS 3” was changed from “10:00/day” to “15:45/day.”

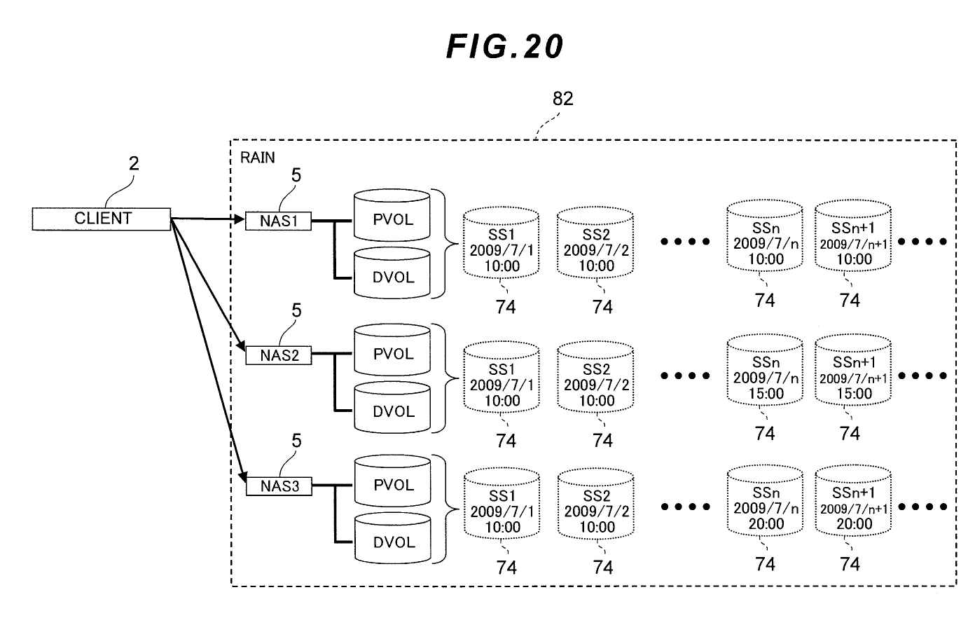

The status after performing the foregoing operation for a while is shown in FIG. 20. FIG. 20 shows a case where, while the acquisition time of the snapshots 74 in the respective NAS apparatuses 5 configuring the RAIN 82 was “10:00/day” during the period from “2009/7/1” to “2009/7/n-1,” the snapshot acquisition time of “NAS 2” and “NAS 3” was changed respectively to “15:00/day” and “20:00/day” on “2009/7/n.”

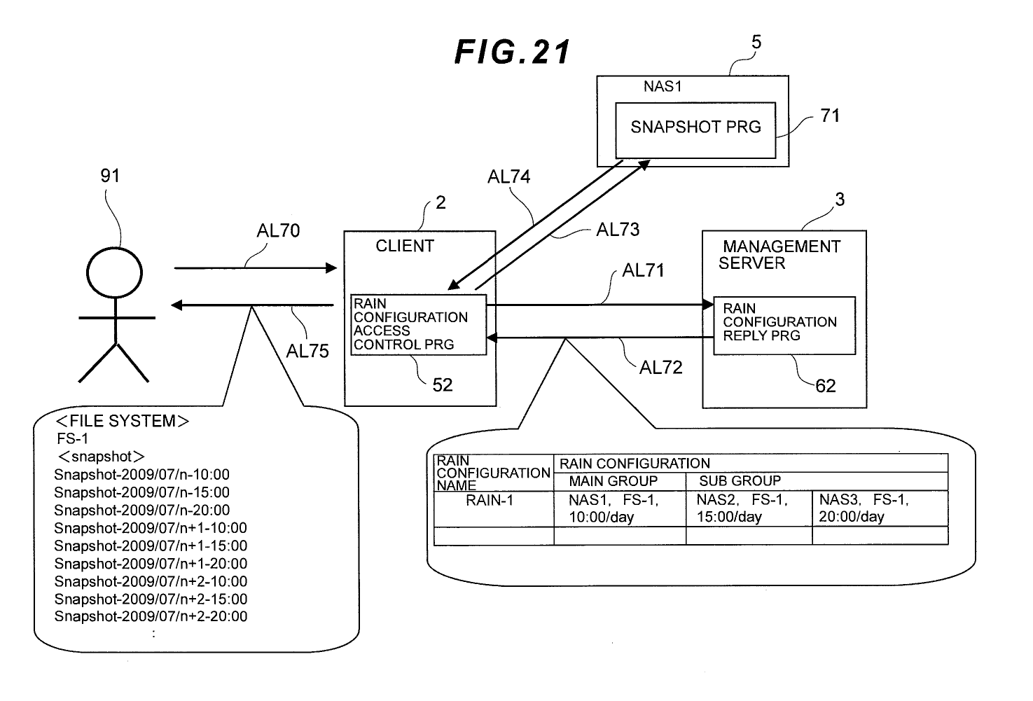

In addition, FIG. 21 shows the relationship of the user 91, the client 2, the management server 3 and the NAS apparatus 5 in a case where, on or after “2009/7/n” of FIG. 20, the user 91 input to the client 2 a display command for displaying the file systems and snapshots that are available to that user 91.

When the user 91 inputs the display command to the client 2 (AL70), the RAIN configuration access control program 52 of the client 2 makes an inquiry to the RAIN configuration reply program 62 of the management server 3 regarding the RAIN configuration of the corresponding RAIN 82 (AL71).

The RAIN configuration reply program 62 acquires, in response to the inquiry, the NAS apparatus information of all NAS apparatuses 5 configuring the RAIN 82 from the RAIN configuration management table 64, and notifies the acquired NAS apparatus information as the RAIN configuration information to the client 2 (AL72).

The RAIN configuration access control program 52 of the client 2 that received the RAIN configuration information requests the respective NAS apparatuses 5 configuring that RAIN 82 to notify the file systems and the snapshots 74 that are available to that user 91 (AL73).

The respective NAS apparatuses 5 that received the foregoing request notify the RAIN configuration access control program 54 of the name of the file systems that are available to that user 91 and management information such as the snapshot name and acquisition time of the respective snapshots 74 that are available to that user 91 (AL74).

Consequently, the RAIN configuration access control program 52 creates a snapshot list indicating the name of file systems that are available to the user 91 and the acquisition time of the respective snapshots 74 that are available to that user 91 based on the name of the file systems and the management information of the respective snapshots 74 that are sent from those NAS apparatuses 5, and presents this to the user 91.

(3-7) Control of Snapshot Acquisition Interval (Part 2)

Meanwhile, the RAIN configuration control program 63 of the management server 3 periodically collects the access log from the respective NAS apparatuses 5 configuring each RAIN 82.

The RAIN configuration control program 63 refers to each of the collected access logs and determines whether the user as previously restored the file using the snapshot 74 due to the erroneous deletion or erroneous correction of such file. Upon obtaining a positive result in the foregoing determination, the RAIN configuration control program 63 specifies the restoration time, and seeks the time difference between the snapshot acquisition time and the restoration time.

If the average value of the time difference falls below the foregoing snapshot control threshold, the RAIN configuration control program 63 requests the NAS management program 61 to return the snapshot time in the respective NAS apparatuses 5 configuring that RAIN 82 to the same snapshot acquisition time. Consequently, the NAS management program 61 that received the foregoing request sequentially accesses the respective NAS apparatuses 5 configuring that RAIN 82, and returns the snapshot acquisition time set in the NAS apparatuses 5 to the original snapshot acquisition time before the change.

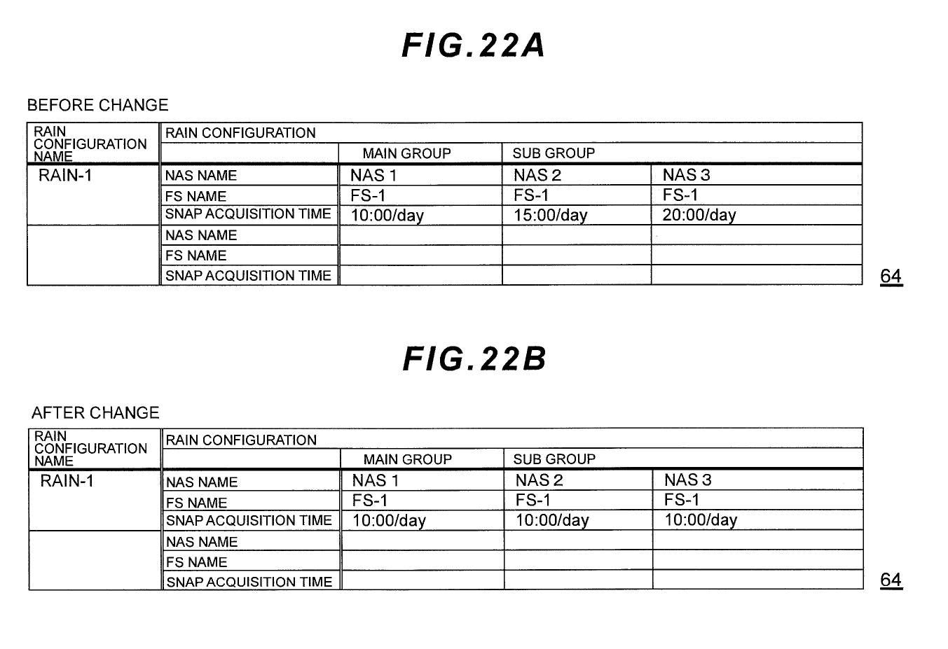

The RAIN configuration control program 63 updates, as shown in FIG. 22, the RAIN configuration management table 64 so as to return the snapshot acquisition time of the respective NAS apparatuses 5 configuring that RAIN 82 registered in the RAIN configuration management table 64 to the snapshot acquisition time before the change.

Incidentally, FIG. 22A shows the RAIN configuration management table 64 before the update, and FIG. 22B shows the RAIN configuration management table 64 after the update. FIG. 22 shows a case where the snapshot acquisition time of the NAS apparatus 5 named “NAS 2” of the RAIN 82 named “RAIN-1” was changed from “15:00/day” to the original “10:00/day,” and the snapshot acquisition time of the NAS apparatus 5 named “NAS 3” was also changed from “20:00/day” to the original “10:00/day.”

### (4) Specific Processing of Respective Programs

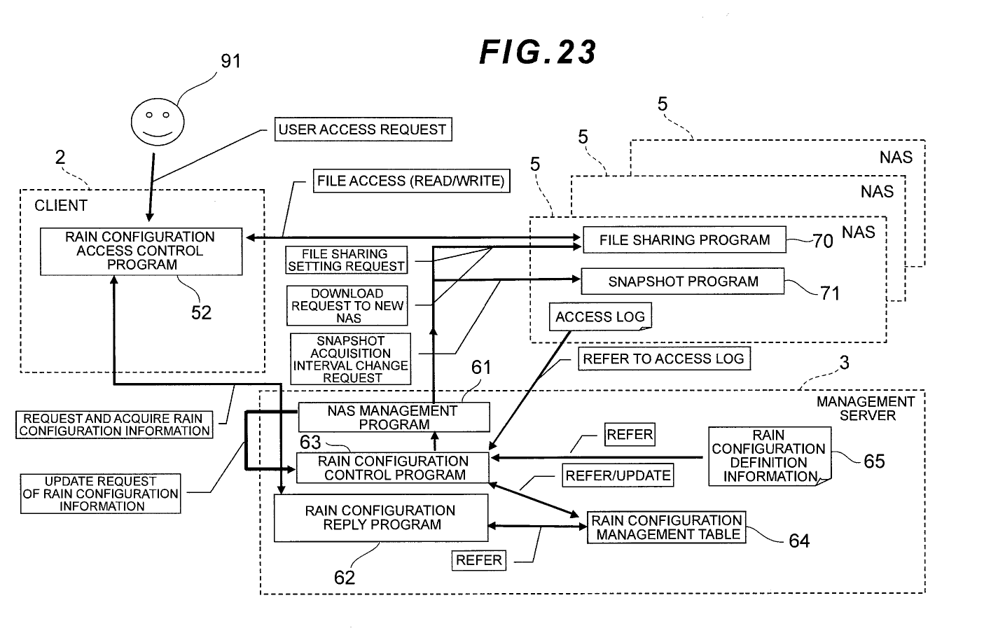

The specific processing contents of various types of processing to be executed by the respective programs concerning the foregoing RAIN management function are now explained. The relationship between the programs is shown in FIG. 23.

(4-1) Processing of RAIN Configuration Access Control Program

(4-1-1) Access Request Processing

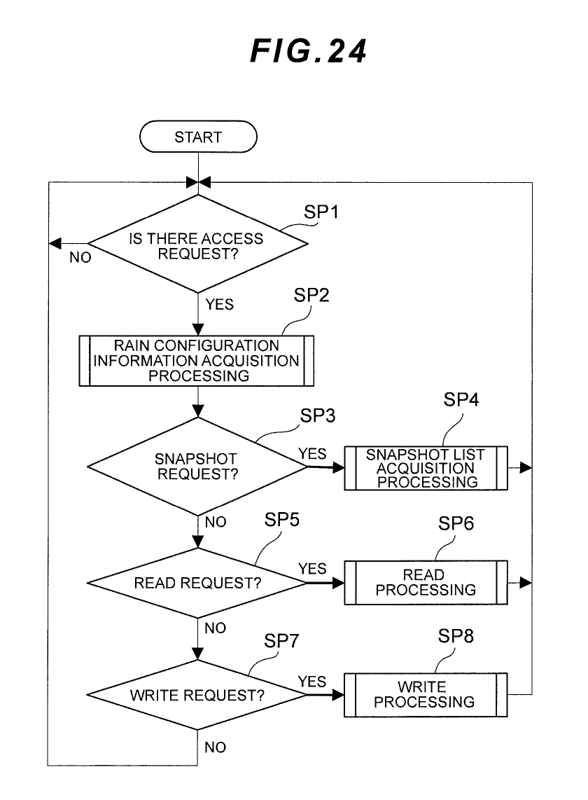

FIG. 24 shows the processing routine of the access request processing to be executed by the RAIN configuration access control program 52 of the client 2 that received the access request from the user to a certain RAIN 82. The RAIN configuration access control program 52 processes the access request from the user according the processing routine shown in FIG. 24.

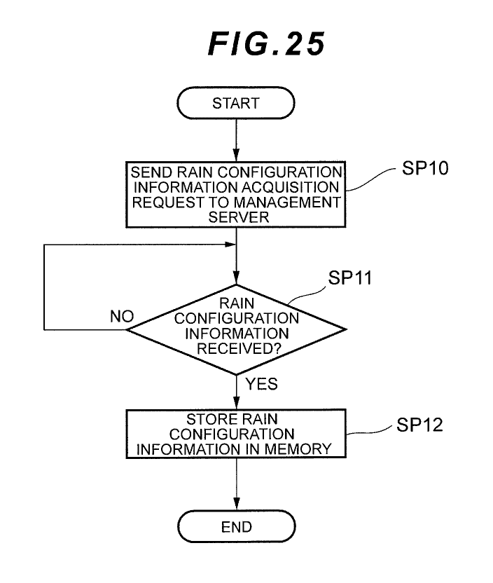

Specifically, the RAIN configuration access control program 52 waits for the access request to be input from the user under normal circumstances (SP1), and, when the access request is eventually input, acquires the RAIN configuration information of the target RAIN (hereinafter referred to as the “target RAIN”) 82 of the access request by executing the RAIN configuration information acquisition processing explained later with reference to FIG. 25 (SP2).

Subsequently, the RAIN configuration access control program 52 determines whether the received access request is a request (hereinafter referred to as the “snapshot acquisition request) for acquiring the snapshot 74 (SP3).

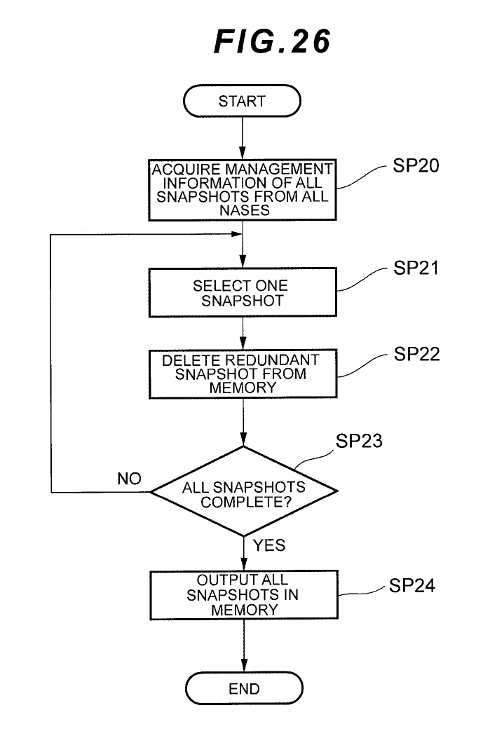

If the RAIN configuration access control program 52 obtains a positive result in the foregoing determination, it creates a list (snapshot list) of the snapshots 74 existing in the target RAIN 82 by executing the snapshot list acquisition processing explained later with reference to FIG. 26, and present the created snapshot list to the user (SP4). The RAIN configuration access control program 52 thereafter returns to step SP1.

Meanwhile, if the RAIN configuration access control program 52 obtains a negative result in the determination at step SP3, it determines whether the received access request is a read request (SP5).

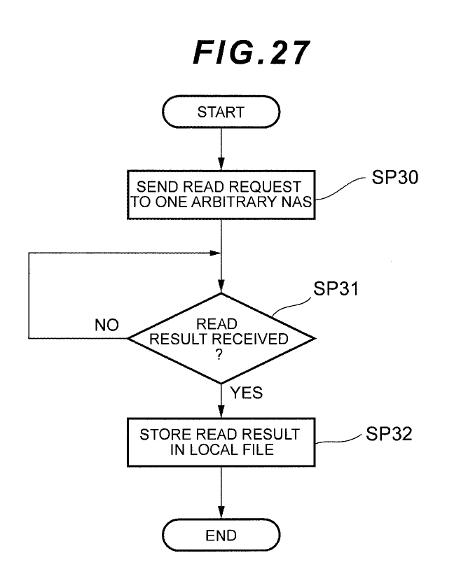

If the RAIN configuration access control program 52 obtains a positive result in the foregoing determination, it reads the file designated in the read request from the operating volume PVOL of one of the NAS apparatuses 5 in the target RAIN 82 by executing the read processing explained later with reference to FIG. 27, and stores the read file in the memory 11 (FIG. 1) of the client 2 (SP6). Consequently, this file is thereafter loaded and opened by software corresponding to the file format of that file. The RAIN configuration access control program 52 thereafter returns to step SP1.

Meanwhile, if the RAIN configuration access control program 52 obtains a negative result in the determination at step SP5, it determines whether the received access request is a write request (SP7).

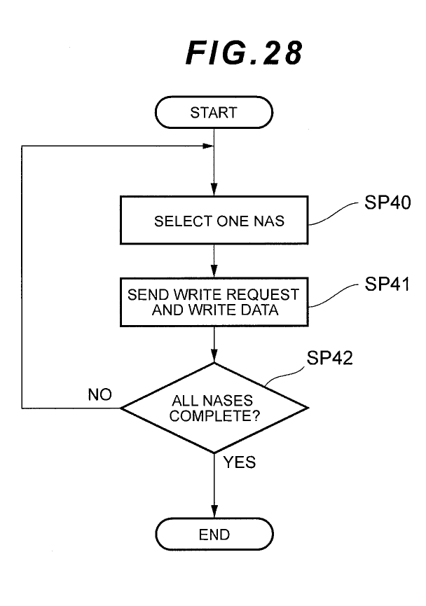

If the RAIN configuration access control program 52 obtains a positive result in the foregoing determination, it writes the write data that was sent together with the write request into the operating volume PVOL of all NAS apparatuses 5 configuring the target RAIN 82 by executing the write processing explained later with reference to FIG. 28 (SP8). The RAIN configuration access control program 52 thereafter returns to step SP1.

(4-1-2) RAIN Configuration Information Acquisition Processing

FIG. 25 shows the specific processing routine of the RAIN configuration information acquisition processing to be executed by the RAIN configuration access control program 52 at step SP2 of the foregoing access request processing.

When the RAIN configuration access control program 52 proceeds to step SP2 of the access request processing, it starts this RAIN configuration information acquisition processing, and foremost sends a RAIN configuration information transfer request to the management server 3 (SP10), and thereafter waits for the RAIN configuration information of the target RAIN 82 to be transferred from the RAIN configuration reply program 62 of the management server 3 according to the RAIN configuration information transfer request (SP11).

When the RAIN configuration information of the target RAIN 82 is eventually transferred from the RAIN configuration reply program 62 of the management server 3, the RAIN configuration access control program 52 stores such RAIN configuration information in the memory 11 (FIG. 1) (SP12). The RAIN configuration access control program 52 thereafter ends the RAIN configuration information acquisition processing, and proceeds to step SP3 of the access request processing (FIG. 24).

(4-1-3) Snapshot List Acquisition Processing

Meanwhile, FIG. 26 shows the specific processing routine of the snapshot list acquisition processing to be executed at step SP4 of the access request processing.

When the RAIN configuration access control program 52 proceeds to step SP4 of the access request processing, it starts the snapshot list acquisition processing, and foremost accesses all NAS apparatuses 5 configuring the target RAIN 82 based on the RAIN configuration information acquired from the RAIN configuration information acquisition processing (FIG. 26), and thereby acquires, from such NAS apparatuses 5, the management information of the respective snapshots 7 that are retained in the NAS apparatuses 5. The RAIN configuration access control program 52 thereafter writes the management information of the respective snapshots 74 acquired from the respective NAS apparatuses 5 into the memory 11 (FIG. 1) (SP20).

Subsequently, the RAIN configuration access control program 52 selects one snapshot 74 among the respective snapshots 74 retained in the respective NAS apparatuses 5 configuring the target RAIN 82 based on the management information of the respective snapshots 74 which were stored in the memory 11 at step SP20 (SP21). The RAIN configuration access control program 52 additionally deletes, from the memory 11, the management information of the other snapshots 74 having the same acquisition time as the snapshot 74 that was selected at step SP21 (SP22).

Subsequently, the RAIN configuration access control program 52 determines whether the processing of step SP21 and step SP22 has been completed for all snapshots 74 retained in the respective NAS apparatuses 5 configuring the target RAIN 82 (SP23).

If the RAIN configuration access control program 52 obtains a negative result in the foregoing determination, it returns to step SP21, and thereafter repeats the processing of step SP21 to step SP23 while sequentially switching the snapshot 74 to be selected at step SP21 to another unprocessed snapshot 74.

If the RAIN configuration access control program 52 obtains a positive result at step SP23 as a result of the processing of step SP21 and step SP22 eventually being completed for all snapshots 74 retained in the respective NAS apparatuses 5 configuring the target RAIN 82, it outputs the management information of all snapshots 74 stored in the memory 11 to prescribed software (not shown) of the client 2 (SP24). Consequently, the list (snapshot list) of snapshots 74 that are available to the user 91 which exist in the target RAIN 82 is displayed on the monitor of the client 2 in a prescribed format based on the function of the software.

The RAIN configuration access control program 52 thereafter ends the snapshot list acquisition processing, and returns to step SP1 of the access request processing (FIG. 24).

(4-1-4) Read Processing

Meanwhile, FIG. 27 shows the specific processing routine of the read processing to be executed at step SP6 of the access request processing.

When the RAIN configuration access control program 52 proceeds to step SP6 of the access request processing, it starts the read processing, and foremost sends a read request of the file designated by the user to one NAS apparatus 5 in the target RAIN 82 (SP30), and thereafter waits for a reply (read result) from that NAS apparatus 5 in response to the read request (SP31).

When the RAIN configuration access control program 52 eventually receives a reply from that NAS apparatus 5 in response to the read request, it stores the acquired read data as a local file in the memory 11 (SP32).

The RAIN configuration access control program 52 thereafter ends the read processing, and returns to step SP1 of the access request processing (FIG. 24).

(4-1-5) Write Processing

FIG. 28 shows the specific processing routine of the write processing to be executed at step SP8 of the access request processing.

When the RAIN configuration access control program 52 proceeds to step SP8 of the access request processing, it starts the write processing, and foremost selects one NAS apparatus 5 in the target RAIN 82 (SP40), and sends a write request and write data to that NAS apparatus 5 (SP41).

Subsequently, the RAIN configuration access control program 52 determines whether a write request and write data has been sent to all NAS apparatuses 5 in the target RAIN 82 (SP42).

If the RAIN configuration access control program 52 obtains a negative result in the foregoing determination, it returns to step SP40, and thereafter repeats the processing of step SP40 to step SP42 until it obtains a positive result at step SP42 while sequentially switching the NAS apparatus 5 to be selected at step SP40 to another unprocessed NAS apparatus 5.

If the RAIN configuration access control program 52 obtains at step SP42 as a result of a write request and write data eventually being sent to all NAS apparatuses 5 in the target RAIN 82, it ends the write processing and thereafter returns to step SP1 of the access request processing (FIG. 24).

(4-2) Processing of RAIN Configuration Reply Program

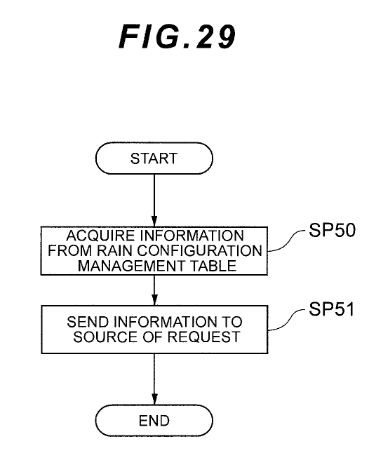

FIG. 29 shows the processing routine of the RAIN configuration information reply processing to be executed by the RAIN configuration reply program 62 of the management serve 3 that received the RAIN configuration information acquisition request sent from the RAIN configuration access control program 52 at step SP10 of the RAIN configuration information acquisition processing explained above with reference to FIG. 25.

When the RAIN configuration reply program 62 receives the RAIN configuration information acquisition request, it starts the RAIN configuration information reply processing shown in FIG. 29, and foremost reads, from the RAIN configuration management table 64 (FIG. 4), the name of the respective NAS apparatuses 5 in the target RAIN 82, the name of the file system loaded in the NAS apparatuses 5, and the snapshot acquisition time set in the respective NAS apparatuses 5 (SP50).

Subsequently, the RAIN configuration reply program 62 sends the information acquired at step SP50 as the RAIN configuration information to the client 2 that sent the RAIN configuration information acquisition request (SP51), and thereafter ends the RAIN configuration information reply processing.

(4-3) Processing of RAIN Configuration Control Program

(4-3-1) RAIN Configuration Control Processing

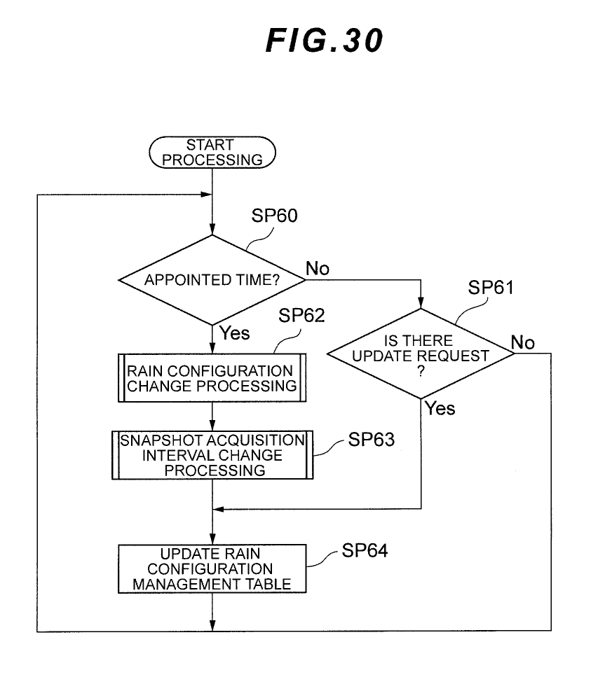

Meanwhile, FIG. 30 shows the processing routine of the RAIN configuration control processing to be executed by the RAIN configuration control program 63 (FIG. 2) of the management server 3. The RAIN configuration control program 63 changes, periodically or in accordance with a request from the NAS management program 61 (FIG. 2), the RAIN configuration of the RAIN 82 or the acquisition interval of the snapshots 74 in the RAIN 82, as needed, according to the processing routine shown in FIG. 30.

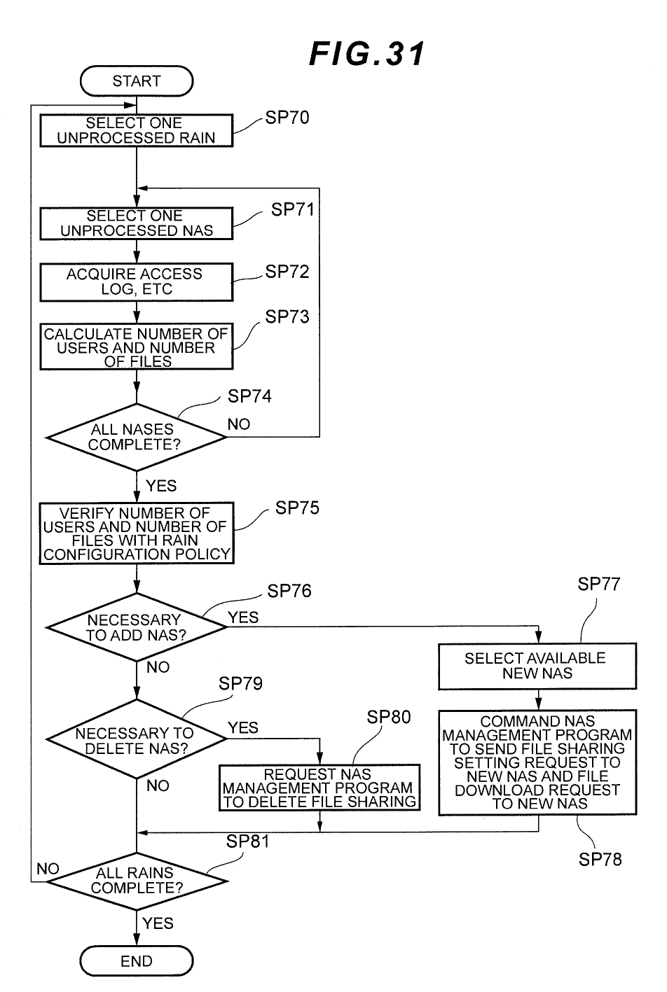

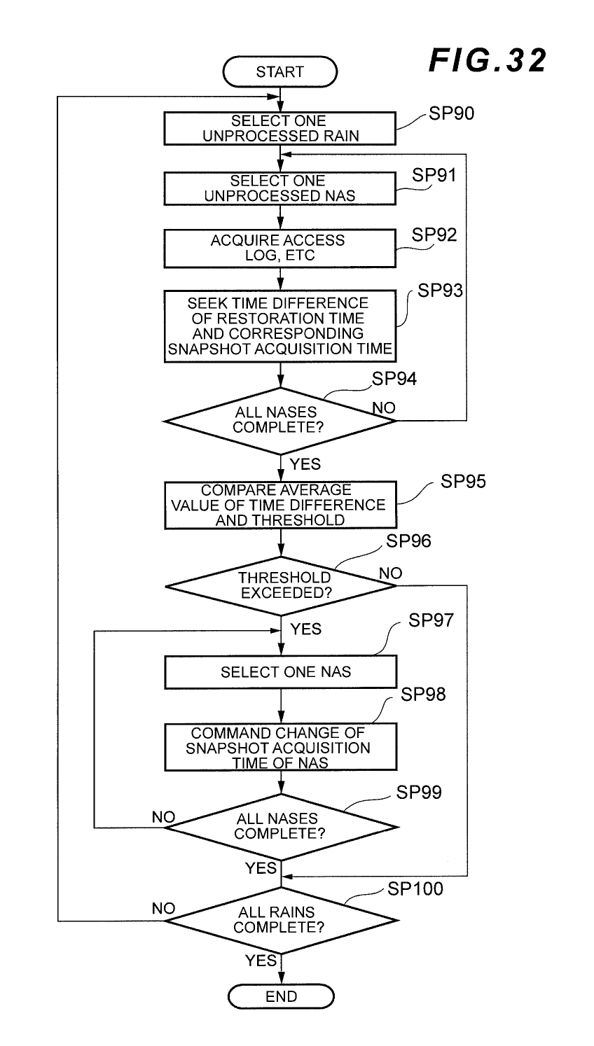

Specifically, the RAIN configuration control program 63 starts the RAIN configuration control processing when the power of the management server 3 is turned on, and foremost determines whether the current time reached a predetermined time as the time for executing the RAIN configuration change processing explained later with reference to FIG. 31 and executing the snapshot acquisition interval change processing explained later with reference to FIG. 32 (SP60).

If the RAIN configuration control program 63 obtains a negative result in the foregoing determination, it determines whether a RAIN configuration management table update request has been sent from the NAS management program 61 (SP61).

If the RAIN configuration control program 63 obtains a negative result in the foregoing determination, it returns to step SP60, and thereafter repeats the processing of step SP60 to step SP61 until it obtains a positive result at step SP60 or step SP61.

When the RAIN configuration control program 63 eventually obtains a positive result at step SP60, it changes the configuration of the RAIN 82 as needed by executing the RAIN configuration change processing explained later with reference to FIG. 31 (SP62).

Subsequently, the RAIN configuration control program 6 3 changes the snapshot acquisition time in the NAS apparatus 5 configuring the RAIN 82 as needed by executing the snapshot acquisition interval change processing explained later with reference to FIG. 32 (SP63).

Subsequently, the RAIN configuration control program 63 updates the RAIN configuration management table 64 as needed according to the processing result of the RAIN configuration change processing of step SP62 and the snapshot acquisition interval change processing of step SP63 (SP64). The RAIN configuration control program 63 thereafter returns to step SP60 and repeats similar processing.

(4-3-2) RAIN Configuration Change Processing

FIG. 31 shows the specific processing routine of the RAIN configuration change processing to be executed at step SP62 of the RAIN configuration control processing (FIG. 30). The RAIN configuration control program 63 changes the configuration of each RAIN 82 registered in the RAIN configuration management table 64 as needed according to this processing routine.

Specifically, when the RAIN configuration control program 63 proceeds to step SP62 of the RAIN configuration control processing, it starts the RAIN configuration change processing, and foremost selects one unprocessed RAIN 82 among the RAINs 82 registered in the RAIN configuration management table 64 (FIG. 4) (SP70).

Subsequently, the RAIN configuration control program 63 refers to the RAIN configuration management table 64 and selects one unprocessed NAS apparatus 5 among the NAS apparatuses 5 configuring the RAIN 82 selected at step SP70 (SP71), and additionally accesses the NAS apparatuses 5 and acquires the access log and other information retained in such NAS apparatuses 5 (SP72).

Subsequently, the RAIN configuration control program 63 calculates the number of accessing users to the NAS apparatuses 5 and the number of accessed files in the NAS apparatuses 5 based on the access log acquired at step SP72 (SP74).

The RAIN configuration control program 63 additionally determines whether the processing of step SP71 to step SP73 has been executed to all NAS apparatuses 5 configuring the RAIN 82 selected at step SP70 (SP74), and returns to step SP71 upon obtaining a negative result. The RAIN configuration control program 63 thereafter repeats the processing of step SP71 to step SP74 until it obtains a positive result at step SP74 while sequentially switching the NAS apparatus 5 to be selected at step SP71 to another unprocessed NAS apparatus 5.

When the RAIN configuration control program 63 obtains a positive result at step SP74 as a result of the processing of step SP71 to step SP73 being executed to all NAS apparatuses 5 configuring the RAIN 82 selected at step SP70, it verifies the total value of the number of accessing users and the total value of the number of accessed files of each NAS apparatus calculated as described above with the number of accessing users and the number of accessed files of the RAIN configuration policy contained in the RAIN configuration definition information 65 (FIG. 5) (SP75).

The RAIN configuration control program 63 thereafter determines whether it is necessary to add a NAS apparatus 5 to that RAIN 82 based on the verification result of step SP75 (SP76). If the RAIN configuration control program 63 obtains a positive result in the foregoing determination, it selects the required number of available NAS apparatuses 5 among the NAS apparatuses that are sorted to the sub group 81 in the RAIN configuration definition information 65 (SP77).

Subsequently, the RAIN configuration control program 63 issues a command to the NAS management program 61 (FIG. 1) so as to perform various settings concerning file sharing and various settings concerning the snapshots 74 to the required number of NAS apparatuses 5 selected at step SP77 in the same contents as the NAS apparatuses 5 belonging to the main group 80 among the NAS apparatuses 5 configuring the target RAIN 82. In addition, the RAIN configuration control program 63 issues a command to the NAS management program 61 so as to control the respective NAS apparatuses 5 selected at step SP77 to download all file data from the NAS apparatuses 5 belonging to the main group 80 (SP78). The RAIN configuration control program 63 thereafter proceeds to step SP81.

Meanwhile, if the RAIN configuration control program 63 obtains a negative result in the determination at step SP76, it determines whether it is necessary to delete a NAS apparatus 5 from the target RAIN 82 based on the verification result of step SP75 (SP79).

If the RAIN configuration control program 63 obtains a negative result in the foregoing determination, it proceeds to step SP81. Meanwhile, if the RAIN configuration control program 63 obtains a positive result in the determination at step SP79, it selects the required number of NAS apparatuses 5 to be deleted among the NAS apparatuses 5 belonging to the sub group 81 among the NAS apparatuses 5 configuring that RAIN 82, and requests the NAS management program 61 (FIG. 1) to delete the various settings for file sharing and the various settings for acquiring snapshots which are set in the NAS apparatuses 5 (SP80). Consequently, the NAS management program 61 that received the foregoing request deletes the various settings for file sharing and the various settings for acquiring snapshots which are set in the designated NAS apparatuses 5. The RAIN configuration control program 63 thereafter proceeds to step SP81.

When the RAIN configuration control program 63 proceeds to step SP81, it determines whether the same processing has been executed to all RAINs 82 registered in the RAIN configuration management table 64 (SP81).

If the RAIN configuration control program 63 obtains a negative result in the foregoing determination, it returns to step SP70, and thereafter repeats the processing of step SP70 to step SP81 until it obtains a positive result at step SP81 while sequentially switching the RAIN 82 to be selected at step SP70 to another unprocessed RAIN 82.

When the RAIN configuration control program 63 obtains a positive result at step SP81 as a result of the same processing eventually being executed to all RAINs 82 registered in the RAIN configuration management table 64, it ends the RAIN configuration change processing, returns to the RAIN configuration control processing (FIG. 30), and proceeds to step SP63 of the RAIN configuration control processing.

(4-3-3) Snapshot Acquisition Interval Change Processing

FIG. 32 shows the specific processing routine of the snapshot acquisition interval change processing to be executed at step SP63 of the RAIN configuration control processing explained above with reference to FIG. 30. The RAIN configuration control program 63 changes the acquisition interval of the snapshots 74 in each RAIN 82 registered in the RAIN configuration management table 64 as needed according to this processing routine.

Specifically, when the RAIN configuration control program 63 proceeds to step SP 63 of the RAIN configuration control processing, it starts the snapshot acquisition interval change processing, and foremost selects one unprocessed RAIN 82 among the RAINs 82 registered in the RAIN configuration management table 64 (FIG. 4) (SP90).

Subsequently, the RAIN configuration control program 63 refers to the RAIN configuration management table 64 and selects one unprocessed NAS apparatus 5 among the NAS apparatuses 5 configuring the RAIN 82 selected at step SP90 (SP91), and additionally accesses such NAS apparatuses 5 and acquires the access log and other information retained in the NAS apparatuses 5 (SP92).

Subsequently, based on the access log acquired at step SP72, if restoration is being performed in that NAS apparatus 5, the RAIN configuration control program 63 seeks the time difference between the time (restoration time) that such restoration was performed and the acquisition time (snapshot acquisition time) of the snapshot 74 that was used in the restoration (SP93).

The RAIN configuration control program 63 further determines whether the processing of step SP91 to step SP93 has been executed to all NAS apparatuses 5 configuring the RAIN 82 selected at step SP90 (SP94), and returns to step SP91 upon obtaining a negative result. The RAIN configuration control program 63 thereafter repeats the processing of step SP91 to step SP94 until it obtains a positive result at step SP94 while sequentially switching the NAS apparatus 5 to be selected at step SP91 to another unprocessed NAS apparatus 5.

When the RAIN configuration control program 63 obtains a positive result at step SP94 as a result of the processing step SP91 to step SP93 eventually being executed to all NAS apparatuses 5 configuring the RAIN 82 selected at step SP90, it calculates the average value of the time difference (hereinafter referred to as the “time difference average value”) between the restoration time and the snapshot time calculated as described above, and compares the time difference calculated value with the foregoing snapshot control threshold (SP95).

The RAIN configuration control program 63 thereafter determines whether the time difference average value exceeded the snapshot control threshold based on the comparative result of step SP95 (SP96), and proceeds to step SP100 upon obtaining a negative result.

Meanwhile, if the RAIN configuration control program 63 obtains a positive result in the determination at step SP96, it selects one NAS apparatus 5 among the NAS apparatuses 5 configuring the RAIN 82 selected at step SP90 (SP97), and seeks, by calculation, the new snapshot acquisition time of that NAS apparatus 5. The RAIN configuration control program 63 sends a snapshot acquisition time change request to the NAS management program 61 for changing the snapshot acquisition time of that NAS apparatus 5 to the new snapshot acquisition time sought by the foregoing calculation (SP98).

The RAIN configuration control program 63 further determines whether the processing step SP97 and step SP98 has been executed to all NAS apparatuses 5 configuring the RAIN 82 selected at step SP90 (SP99), and returns to step SP97 upon obtaining a negative result. The RAIN configuration control program 63 thereafter repeats the processing of step SP97 to step SP99 until it obtains a positive result at step SP99 while sequentially switching the NAS apparatus 5 to be selected at step SP97 to another NAS apparatus 5.

When the RAIN configuration control program 63 obtains a positive result at step SP99 as a result of the processing of step SP97 and step SP98 eventually being executed to all NAS apparatuses 5 configuring the RAIN 82 selected at step SP90, it ends the snapshot acquisition interval change processing, returns to the RAIN configuration control processing (FIG. 30), and proceeds to step SP64 of the RAIN configuration control processing.

### (5) Effect of Present Embodiment

As described above, with the computer system 1, the acquisition time of the snapshots 74 in the required NAS apparatuses 5 among the NAS apparatuses 5 configuring the RAIN 82 is changed based on the time difference between the restoration time of the file in the RAIN 82 and the acquisition time of the snapshot 74 that used in such restoration. Accordingly, with the computer system 1, for example, in a state where the restoration of the file is arbitrarily performed, it is possible to reduce the amount of data loss (backdate amount) during the restoration on the one hand, and in a state when the restoration of the file is not performed, even if a fault occurs in the NAS apparatus 5 belonging to the main group 80 and the processing is subject to a failover to the NAS apparatus 5 belonging to the sub group 81, the user is able to continue to refer to the snapshot 74 that was acquired at the same time.

Thus, according to the computer system 1, it is possible to enjoy both advantages; namely, the advantage of being able to make the snapshot acquisition time of the respective NAS apparatuses 5 configuring the RAIN 82 to all be the same time, and the advantage that can be acquired by causing the snapshot acquisition time of a part or all of the NAS apparatuses 5 configuring the RAIN 82 to be different. Consequently, it is possible to improve the user-friendliness of the computer system.

Moreover, with the computer system 1, since the configuration of the RAIN 82 is changed as needed (adding a NAS apparatus 5 to the RAIN 82 or deleting a NAS apparatus 5 from the RAIN 82 as needed) based on the number of accessing users and the number of accessed files in the RAIN 82, data protection can be reinforced through redundancy for a RAIN 82 with a high number of accessing users and a high number of accessed files, and the wasteful use of the NAS apparatuses 5 can be suppressed for a RAIN 82 with a low number of accessing users and a low number of accessed files.

In the foregoing case, with the computer system 1, it is possible to improve the user-friendliness of the computer system 1 since the change of configuration of the RAIN 82 is performed based on the control of the management server 3 without requiring any manual labor.

### (6) Other Embodiments

In the foregoing embodiment, although a case was explained where the computer system 1 is configured as shown in FIG. 1, the present invention is not limited thereto, and, for instance, the function of the management server 3 and the function of the management apparatus 4 may be loaded on a single server apparatus.

Moreover, in the foregoing embodiment, although a case was explained where whether to change the acquisition time of the snapshots 74 in the NAS apparatuses 5 configuring the RAIN 82 was determined based on the average value of the time difference between the restoration time of the file in the RAIN 82 and the acquisition time of the snapshot 74 that was used in the restoration, the present invention is not limited thereto, and, for example, whether to change the acquisition time of the snapshots 74 in the NAS apparatuses 5 configuring the RAIN 82 can also be determined based on the status of variance (dispersion) of such time difference.

Further, in the foregoing embodiment, although a case was explained where the snapshot acquisition time of all NAS apparatuses 5 belonging to the sub group 81 is changed upon changing the snapshot acquisition time of the respective NAS apparatuses 5 configuring the RAIN 82, the present invention is not limited thereto, and the snapshot acquisition time of only certain NAS apparatuses 5 belonging to the sub group 81 can also be changed. The snapshot acquisition time in the NAS apparatuses 5 belonging to the main group 80 can also be changed.

In addition, in the foregoing embodiment, although a case was explained where whether to change the RAIN configuration of the RAIN 82 was determined based on the number of accessing users and the number of accessed files in the RAIN 82, the present invention is not limited thereto, and whether to change the RAIN configuration of the RAIN 82 can also be determined based on only either piece of information. In the foregoing case, whether to change the RAIN configuration of the RAIN 82 can also be decided not based on the number of accessing users, but simply based on the number of users who accessed the RAIN 82, or not based on the number of accessed files, but based on the number of files existing in the RAIN 82.

Moreover, in the foregoing embodiment, although a case was explained where the management unit for managing the NAS apparatus 5 in the management server 3 was configured from the NAS management program 61 stored in the memory 21 of the management server 3 and the CPU 20 for executing such NAS management program 61, and configuring the configuration control unit for controlling the configuration of the RAIN 82 in the management server 3 from the RAIN configuration control program 63 stored in the memory 21 of the management server 3 and the CPU 20 for executing such RAIN configuration control program 63, the present invention is not limited thereto, and the functions of the foregoing management unit and the configuration control unit may also be realized with a single program and the CPU 20 for executing such program, and the foregoing management unit and the configuration control unit may also be of a hardware configuration.

The present invention can be suitably applied to computer systems including a plurality of NAS apparatus respectively loaded with a snapshot function, and to which the RAIN technology is applied.

What is claimed is:

1. A computer system including a plurality of nodes for providing to a host system a storage area to be used for reading and writing data and a management server for managing the plurality of nodes, and which configures a node group from a part or all of the nodes among the plurality of nodes and makes data redundant in node units in the node group,
wherein the plurality of nodes respectively acquire a snapshot as a static image of the storage area at a pre-set time,
wherein the management server comprises:
a management unit for managing the plurality of nodes; and
a configuration control unit for controlling the configuration of the node group,
wherein the configuration control unit acquires an access log from the respective nodes configuring the node group, determines the usage of the snapshot in the node group based on the acquired access log of the respective nodes, and requests the management unit to change the acquisition time of the snapshot in a part or all of the nodes among the nodes configuring the node group based on the determination result, and
wherein the management unit changes the acquisition time of the snapshot set in the corresponding node according to the request from the configuration control unit.

2. The computer system according to claim 1,
wherein the configuration control unit determines the usage of the respective nodes based on the access log acquired from the respective nodes configuring the node group, and adds a node to the node group or deletes a node from the node group as needed based on the determination result.

3. The computer system according to claim 1,
wherein the configuration control unit determines the usage of the snapshot in the node group based on the time difference between the time that the restoration of data was performed based on the access log acquired from the respective nodes configuring the node group and the acquisition time of the snapshot that was used in the restoration.

4. The computer system according to claim 3,
wherein the configuration control unit determines the usage of the snapshot in the node group by comparing the average value of the time difference between the time that the restoration of data was performed and the acquisition time of the snapshot used in the restoration, and a predetermined threshold.

5. The computer system according to claim 2,
wherein the configuration control unit detects the number of accessing users and/or number of accessed files in the node group based on the access log acquired from the respective nodes configuring the node group, and determines the usage of the respective nodes configuring the node group based on the detected number of accessing users and/or number of accessed files.

6. The computer system according to claim 5,
wherein the configuration control unit stores a configuration policy defining the relationship between the total value of the number of accessing users of the node group and/or the number of access files in the node group, and the number of nodes of the node group, and determines the number of nodes to be added or deleted based on the number of accessing users and/or number of accessed files in the node group detected based on the access log acquired from the respective nodes configuring the node group, and the configuration policy.

7. A management method of a computer system including a plurality of nodes for providing to a host system a storage area to be used for reading and writing data and a management server for managing the plurality of nodes, and which configures a node group from a part or all of the nodes among the plurality of nodes and makes data redundant in node units in the node group,
wherein the plurality of nodes respectively acquire a snapshot as a static image of the storage area at a pre-set time,
wherein the method comprises:
a first step of acquiring an access log from the respective nodes configuring the node group; and
a second step of determining the usage of the snapshot in the node group based on the acquired access log of the respective nodes, and changing the acquisition time of the snapshot in a part or all of the nodes among the nodes configuring the node group based on the determination result.

8. The management method of a computer system according to claim 7,
wherein, at the second step, the usage of the respective nodes is determined based on the access log acquired from the respective nodes configuring the node group, and a node is added to the node group or a node is deleted from the node group as needed based on the determination result.

9. The management method of a computer system according to claim 7,
wherein, at the second step, the usage of the snapshot in the node group is determined based on the time difference between the time that the restoration of data was performed based on the access log acquired from the respective nodes configuring the node group and the acquisition time of the snapshot that was used in the restoration.

10. The management method of a computer system according to claim 9,
wherein, at the second step, the usage of the snapshot in the node group is determined by comparing the average value of the time difference between the time that the restoration of data was performed and the acquisition time of the snapshot used in the restoration, and a predetermined threshold.

11. The management method of a computer system according to claim 8,
wherein, at the second step, the number of accessing users and/or number of accessed files in the node group is detected based on the access log acquired from the respective nodes configuring the node group, and the usage of the respective nodes configuring the node group is determined based on the detected number of accessing users and/or number of accessed files.

12. The management method of a computer system according to claim 1
wherein, at the second step, the number of nodes to be added or deleted is determined based on a configuration policy defining the relationship between the total value of the number of accessing users of the node group and/or the number of access files in the node group, and the number of nodes of the node group, and the number of accessing users and/or number of accessed files in the node group detected based on the access log acquired from the respective nodes configuring the node group
